(19) United States
(12) Patent Application Publication
(10) Pub. No.: US 2024/0276554 A1
(43) Pub. Date: Aug. 15, 2024

(54) UE INITIATED UNIFIED TCI SWITCHING

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/577,540

(22) PCT Filed: Aug. 6, 2021
(86) PCT No.: PCT/CN2021/111117

§ 371 Date: Jan. 8, 2024

(51) Int. Cl. H04W 74/0833; H04B 7/06; H04W 72/12

(52) U.S. Cl. CPC H04W 74/0833; H04B 7/0626; H04B 7/06968; H04W 72/12

(57) ABSTRACT

Methods, apparatuses, and computer readable medium for beam switch are provided. An example method may include receiving, from a base station, at least one of a scheduling request (SR) configuration to indicate a request for a beam switch or a physical random access channel (PRACH) configuration representing a set of PRACH resources to indicate the request for the beam switch. The example method may further include transmitting, to the base station, a PRACH or an SR in a physical uplink control channel (PUCCH) that indicates the request for the beam switch for one or more downlink (DL) or uplink (UL) channels.

### TECHNICAL FIELD

The present disclosure relates generally to communication systems, and more particularly, to wireless communication systems with UE initiated transmission configuration indicator (TCI) switching.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a base station, at least one of a scheduling request (SR) configuration to indicate a request for a beam switch or a physical random access channel (PRACH) configuration representing a set of PRACH resources to indicate the request for the beam switch. The memory and the at least one processor coupled to the memory may be further configured to transmit, to the base station, a PRACH or an SR in a physical uplink control channel (PUCCH) that indicates the request for the beam switch for one or more downlink (DL) or uplink (UL) channels.

In another aspect of the disclosure, a method, a computer-readable medium, and an apparatus at a base station are provided. The apparatus may include a memory and at least one processor coupled to the memory. The memory and the at least one processor coupled to the memory may be configured to transmit, to the UE, at least one of an SR configuration to indicate a request for a beam switch or a PRACH configuration representing a set of PRACH resources to indicate the request for the beam switch. The memory and the at least one processor coupled to the memory may be further configured to transmit, to the base station, a PRACH or an SR in a PUCCH that indicates the request for the beam switch for one or more DL or UL channels.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A and 4B are diagrams illustrating a base station in communication with a UE via a set of beams.

FIG. 5 is a diagram illustrating a base station in communication with a UE via a set of beams.

FIG. 6 is a diagram illustrating a UE initiated CSI request procedure.

FIG. 7 is a diagram illustrating a beam switch procedure.

FIG. 8 is a diagram illustrating example UE initiated CSI requests and associated beam switch procedures.

FIG. 9 is a diagram illustrating example UE initiated CSI requests and associated beam switch procedures.

FIG. 10 is a diagram illustrating example UE initiated CSI requests and associated beam switch procedures.

FIG. 11 is a diagram illustrating example UE initiated CSI requests and associated beam switch procedures.

FIG. 12 is a diagram illustrating example UE initiated CSI requests and associated beam switch procedures.

FIG. 13 is a diagram illustrating example UE initiated CSI requests and associated beam switch procedures.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus.

FIG. 19 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

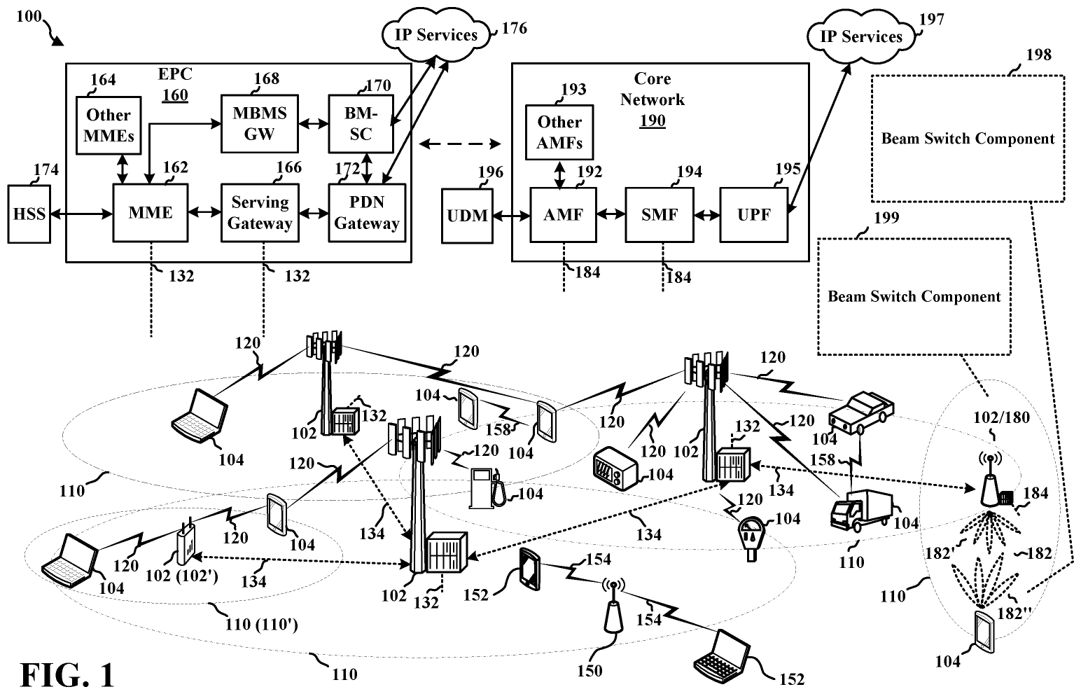

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a beam switch component 198. In some aspects, the beam switch component 198 may be configured to receive, from a base station, at least one of an SR configuration to indicate a request for a beam switch or a PRACH configuration representing a set of PRACH resources to indicate the request for the beam switch. In some aspects, the beam switch component 198 may be further configured to transmit, to the base station, a PRACH or an SR in a PUCCH that indicates the request for the beam switch for one or more DL or UL channels.

In certain aspects, the base station 180 may include a beam switch component 199. In some aspects, the beam switch component 199 may be configured to transmit, to a UE, at least one of an SR configuration to indicate a request for a beam switch or a PRACH configuration representing a set of PRACH resources to indicate the request for the beam switch. In some aspects, the beam switch component 199 may be further configured to receive, from the UE, a PRACH or an SR in a PUCCH that indicates the request for the beam switch for one or more DL or UL channels.

Although the following description may be focused on 5G NR, the concepts described herein may be applicable to other similar areas, such as LTE, LTE-A, CDMA, GSM, and other wireless technologies.

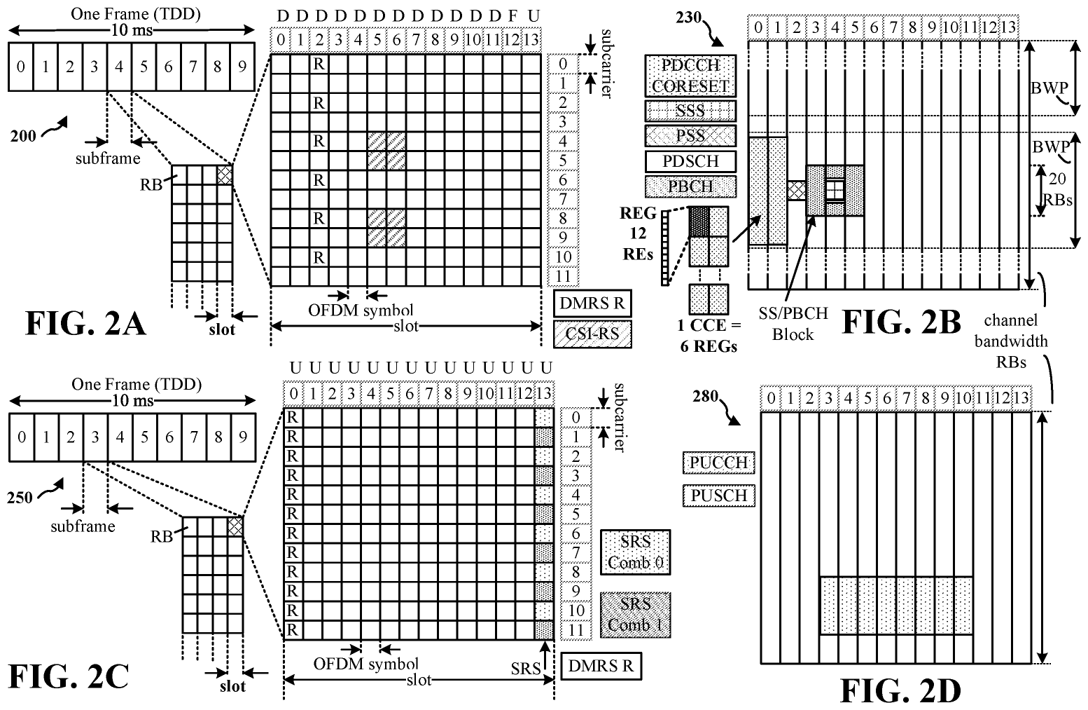

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

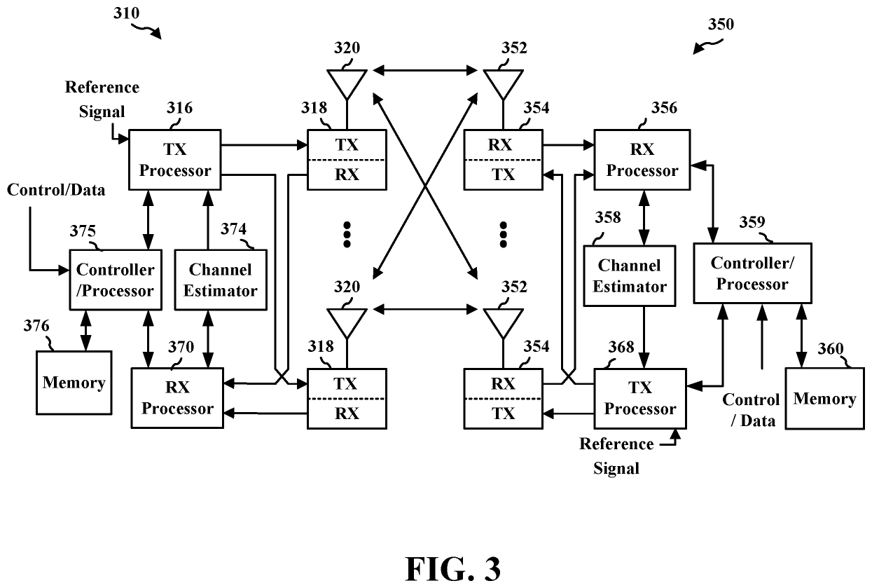

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the beam switch component 198 of FIG. 1.

At least one of the TX processor 316, the RX processor 370, and the controller/processor 375 may be configured to perform aspects in connection with beam switch component 199 of FIG. 1.

A UE may use a random access procedure in order to communicate with a base station. For example, the UE may use the random access procedure to request an radio resource control (RRC) connection, to re-establish an RRC connection, resume an RRC connection, etc. A UE may use a random access procedure in order to communicate with a base station. For example, the UE may use the random access procedure to request an RRC connection, to re-establish an RRC connection, resume an RRC connection, etc. Random Access Procedures may include two different random access procedures, e.g., The UE may use Contention Based Random Access (CBRA) may be performed when a UE is not synchronized with a base station, and the Contention Free Random Access (CFRA) may be applied, e.g., when the UE was previously synchronized to a base station 604. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

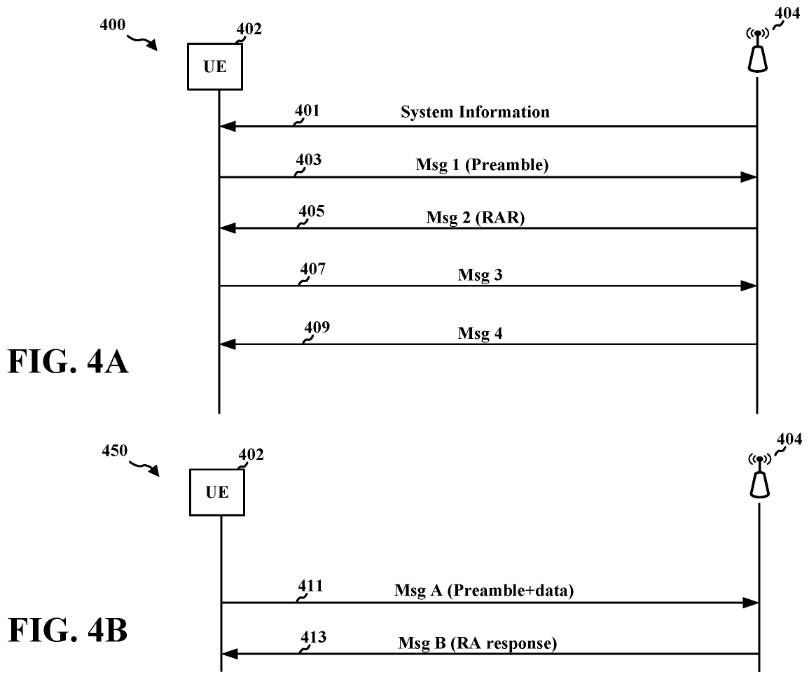

FIG. 4A illustrates example aspects of a random access procedure 400 between a UE 402 and a base station 404. The UE 402 may initiate the random access message exchange by sending, to the base station 404, a first random access message 403 (e.g., Msg 1) including a preamble. Prior to sending the first random access message 403, the UE may obtain random access parameters (which may be otherwise referred to as PRACH configurations), e.g., including preamble format parameters, time and frequency resources, parameters for determining root sequences and/or cyclic shifts for a random access preamble, etc., e.g., in system information 401 from the base station 404. The preamble may be transmitted with an identifier, such as a Random Access RNTI (RA-RNTI). The UE 402 may randomly select a random access preamble sequence, e.g., from a set of preamble sequences. If the UE 402 randomly selects the preamble sequence, the base station 404 may receive another preamble from a different UE at the same time. In some examples, a preamble sequence may be assigned to the UE 402.

The base station may respond to the first random access message 403 by sending a second random access message 405 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR 405, the UE 402 may transmit a third random access message 407 (e.g., Msg 3) to the base station 404, e.g., using PUSCH, that may include a RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs sent a same preamble at 703, both UEs may receive the RAR leading both UEs to send a third random access message 407. The base station 404 may resolve such a collision by being able to decode the third random access message from only one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the RAR 409.

In order to reduce latency or control signaling overhead, a single round trip cycle between the UE and the base station may be achieved in a 2-step RACH process 450, such as shown in FIG. 4B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 402 transmits the Msg A 411, the UE 402 may wait for a response from the base station 404. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fallback to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 413 that completes the two-step RACH procedure. The Msg B may include the random access response and a contention-resolution message. The contention resolution message may be sent after the base station successfully decodes the PUSCH transmission.

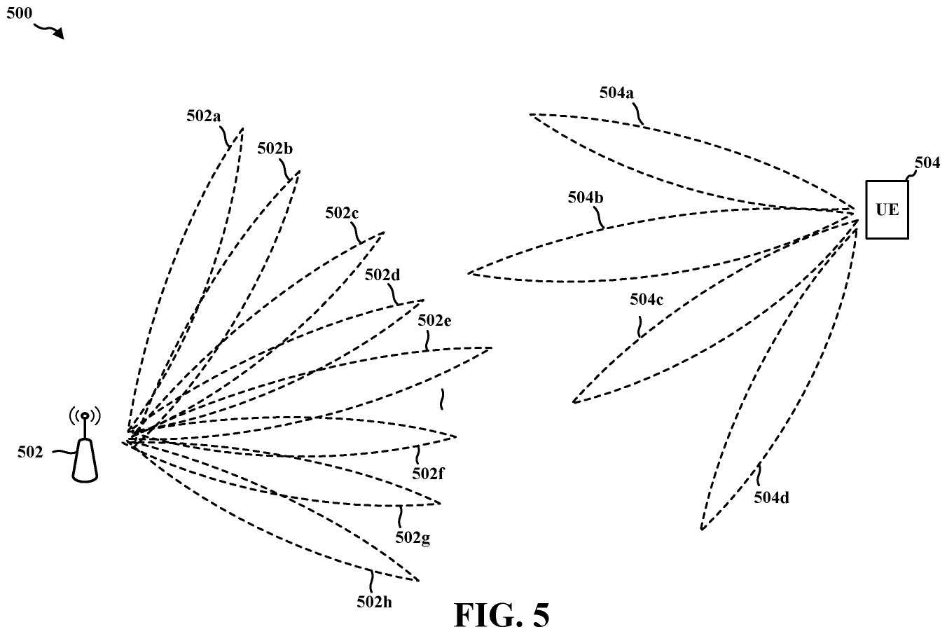

FIG. 5 is a diagram 500 illustrating a base station 502 in communication with a UE 504. Referring to FIG. 5, the base station 502 may transmit a beamformed signal to the UE 504 in one or more of the directions 502a, 502b, 502c, 502d, 502e, 502f, 502g, 502h. The UE 504 may receive the beamformed signal from the base station 502 in one or more receive directions 504a, 504b, 504c, 504d. The UE 504 may also transmit a beamformed signal to the base station 502 in one or more of the directions 504a-504d. The base station 502 may receive the beamformed signal from the UE 504 in one or more of the receive directions 502a-502h. The base station 502/UE 504 may perform beam training to determine the best receive and transmit directions for each of the base station 502/UE 504. The transmit and receive directions for the base station 502 may or may not be the same. The transmit and receive directions for the UE 504 may or may not be the same. The term beam may be otherwise referred to as “spatial filter”. Beamforming may be otherwise referred to as “spatial filtering”.

In response to different conditions, the UE 504 may determine to switch beams, e.g., between beams 502a-502h. The beam at the UE 504 may be used for reception of downlink communication and/or transmission of uplink communication. In some examples, the base station 502 may send a transmission that triggers a beam switch by the UE 504. A TCI state may include Quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the base station 502 may indicate a TCI state change, and in response, the UE 504 may switch to a new beam (which may be otherwise referred to as performing a beam switch) according to the new TCI state indicated by the base station 502.

In some wireless communication systems, such as a wireless communication system under a unified TCI framework, a pool of joint DL/UL TCI states may be used for joint DL/UL TCI state updates for beam indication. For example, the base station 502 may transmit a pool of joint DL/UL TCI states to the UE 504. The UE 504 may determine to switch transmission beams and/or reception beams based on the joint DL/UL TCI states. In some aspects, the TCI state pool for separate DL and UL TCI state updates may be used. In some aspects, the base station 502 may use RRC signaling to configure the TCI state pool. In some aspects, the joint TCI may or may not include UL specific parameter(s) such as UL PC/timing parameters, PLRS, panel-related indication, or the like. If the joint TCI includes the UL specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 5 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

In some aspects, the UL TX spatial filter may also apply to all SRS resources in resource set(s) configured for antenna switching, codebook-based, or non-codebook-based UL transmissions.

In some aspects, each of the following DL RSs may share the same indicated TCI state as UE-dedicated reception on PDSCH and for UE-dedicated reception on all or subset of CORESETs in a CC: CSI-RS resources for CSI, some or all CSI-RS resources for beam management, CSI-RS for tracking, and DM-RS(s) associated with UE-dedicated reception on PDSCH and all/subset of CORESETs. Some SRS resources or resource sets for beam management may share the same indicated TCI state as dynamic-grant/configured-grant based PUSCH, all or subset of dedicated PUCCH resources in a CC. In some wireless communication systems, several QCL rules may be defined. For example, a first rule may define that TCI to DM-RS of UE dedicated PDSCH and PDCCH may not have SSB as a source RS to provide QCL type D information. A second rule may define that TCI to some DL RS such as CSI-RS may have SSB as a source RS to provide QCL type D information. A third rule may define that TCI to some UL RS such as SRS can have SSB as a source RS to provide spatial filter information. Example aspects provided herein enable a UE to signal capability of applying unified TCI to RS, provide QCL indication to DL RS, and provide hybrid spatial filter indication to UL RS.

In some wireless communication systems, to facilitate a common TCI state ID update and activation to provide common QCL information at least for UE-dedicated PDCCH/PDSCH (e.g., common to UE-dedicated PDCCH and UE-dedicated PDSCH) or common UL TX spatial filter(s) at least for UE-dedicated PUSCH/PUCCH across a set of configured CCs/BWPs (e.g., common to multiple PUSCH/PUCCH across configured CCs/BWPs), several configurations may be provided. For example, the RRC-configured TCI state pool(s) may be configured as part of the PDSCH configuration (such as in a PDSCH-Config parameter) for each BWP or CC. The RRC-configured TCI state pool(s) may be absent in the PDSCH configuration for each BWP/CC, and may be replaced with a reference to RRC-configured TCI state pool(s) in a reference BWP/CC. For a BWP/CC where the PDSCH configuration contains a reference to the RRC-configured TCI state pool(s) in a reference BWP/CC, the UE may apply the RRC-configured TCI state pool(s) in the reference BWP/CC. When the BWP/CC identifier (ID) (e.g., for a cell) for QCL-Type A or Type D source RS in a QCL information (such as in a QCL info parameter) of the TCI state is absent, the UE may assume that QCL-Type A or Type D source RS is in the BWP/CC to which the TCI state applies. In addition, a UE may report a UE capability indicating a maximum number of TCI state pools that the UE can support across BWPs and CCs in a band.

Before receiving a TCI state, a UE may assume that the antenna ports of one DM-RS port group of a PDSCH are spatially quasi-colocated (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, a maximum number of TCI states may be 128.

In some aspects, a UE may receive a signal, from a base station, configured to trigger a TCI state change via, for example, a medium access control (MAC) control element (CE) (MAC-CE), a downlink control information (DCI), or a radio resource control (RRC) signal. The TCI state change may cause the UE to find the best or most suitable UE receive beam corresponding to the TCI state indicated by the base station, and switch to such beam. Switching beams may allow for an enhanced or improved connection between the UE and the base station by ensuring that the transmitter and receiver use the same configured set of beams for communication.

In some aspects, a spatial relation change, such as a spatial relation update, may trigger the UE to switch beams. Beamforming may be applied to uplink channels, such as a PUSCH, a PUCCH, or an SRS, or downlink channels, such as PDCCH, PDSCH, or the like. Beamforming may be based on configuring one or more spatial relations between the uplink and downlink signals. Spatial relation indicates that a UE may transmit the uplink signal using the same beam used for receiving the corresponding downlink signal.

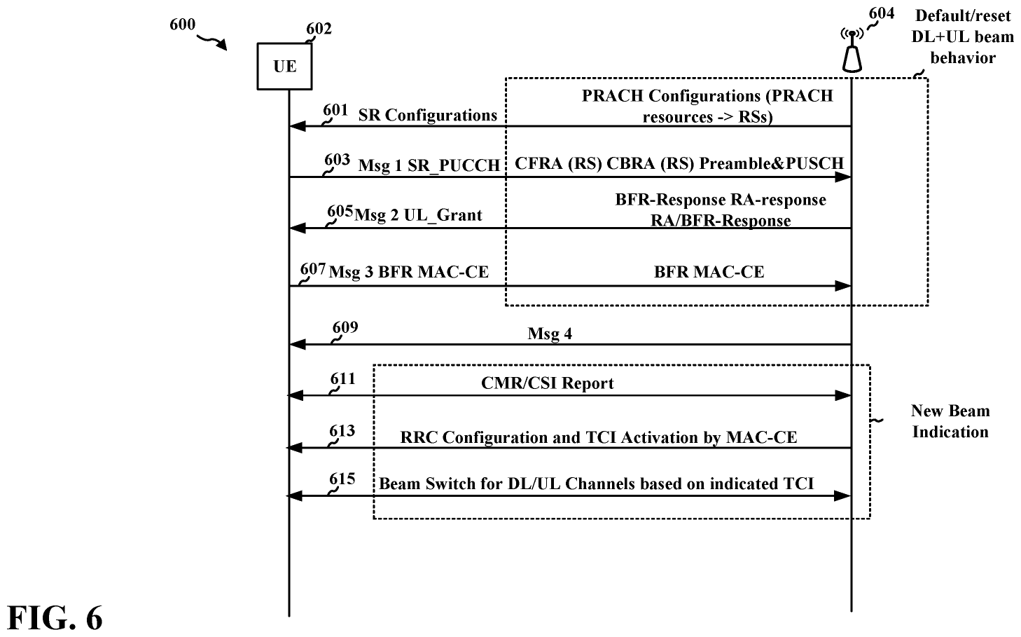

FIG. 6 is a diagram 600 illustrating a beam failure recovery procedure. A MAC entity of the UE 602 may be configured by RRC with a beam a beam failure recovery procedure which may be used for indicating to the serving base station (such as the base station 604) of a new SSB or CSI-RS when beam failure is detected on the serving SSB(s)/CSI-RS(s). Beam failure may be detected by counting beam failure instance indication from the lower layers to the MAC entity.

As illustrated in FIG. 6, the base station 604 may transmit a set of configurations 601 to the UE 602. In some aspects, the set of configurations 601 may be SR configurations. In some aspects, the set of configurations 601 may be associated with and indicate a set of PRACH configurations associated with a default DL/UL beam or a reset behavior associated with a DL/UL beam. The set of PRACH configurations may include PRACH resources associated with (e.g., mapped to) RSs. The set of configurations 601 may include, by way of example, one or more SR configurations that may each correspond to one or more logical channels. Each logical channel may be mapped to zero or one SR configuration, which may be configured by RRC signaling. After receiving the set of configurations 601, the UE 602 may transmit a first message 603 (Msg 1). In some aspects, the first message 603 may be associated with an SR PUCCH. In some aspects, the first message 603 may be associated with (e.g., include or indicate) parameters associated with a default DL/UL beam or a reset behavior associated with a DL/UL beam such as CFRA RS, CBRA RS, preamble or PUSCH associated with the beam, or the like. In some aspects, the first message 603 may be transmitted after detecting a beam failure. The UE 602 may perform beam failure recovery based on CFRA or CBRA. The base station 604 may transmit a second message 605 (Msg 2). In some aspects, the second message 605 may be associated with an UL grant. In some aspects, the second message 605 may be associated with various beam failure and RA responses such as BFR response, RA response, or RA/BFR response. The UE 602 may transmit a third message (Msg 3) 607 associated with a BFR MAC-CE to the base station 604. The BFR MAC-CE may be based on the UL grant. The base station 604 may further transmit a fourth random access message 609, which may include downlink control information (DCI). The UE 602 may exchange channel measurement (CMR) or CSI report 611 with the base station 604. Based on the CMR or CSI report 611, the base station 604 may indicate a new beam via RRC configuration and TCI activation by MAC-CE 613. The new beam may be associated with a new indicated TCI. Based on the new beam and the associated new indicated TCI, the base station 604 and the UE 602 may perform a beam switch for DL/UL channels based on the newly indicated TCI at 615.

To facilitate more efficient beam refinement and tracking, in some aspects, a UE initiated beam selection or activation may be performed based on a beam measurement at a UE without a beam indication or activation from the network. In some aspects, a UE initiated beam switch may be triggered at a UE based on various measurements or reports related to one or more beams and may be independent of a beam activation or indication from a base station. For example, a UE may transmit a CSI report indicating a particular beam index for communication with a base station, and the UE may trigger an implicit beam switch based on the CSI report. The term “implicit beam switch” may refer to a UE initiated beam selection or activation without an explicit beam indication or activation from the network. By utilizing such an implicit beam switch, beam switching latency may be reduced. Signaling overhead may also be reduced.

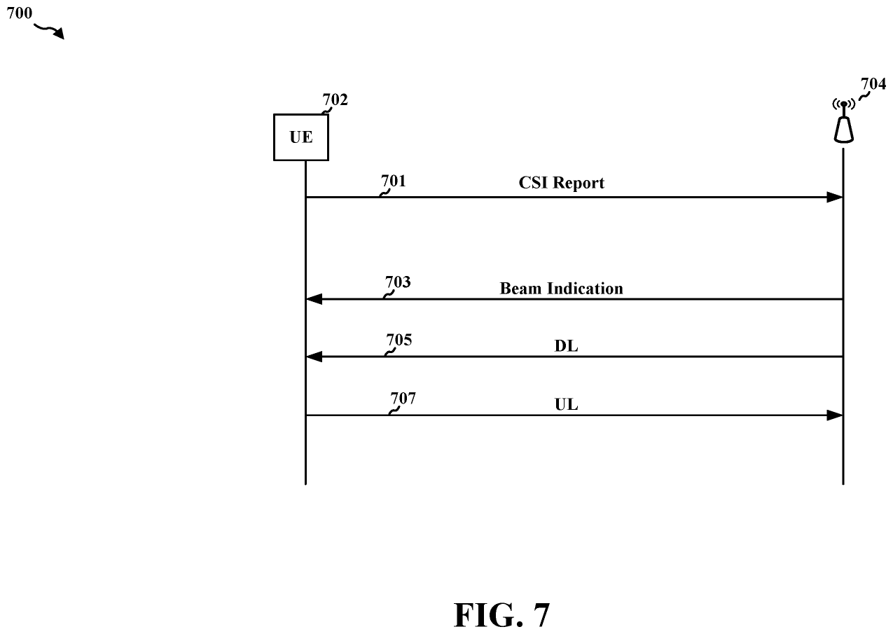

FIG. 7 is a diagram 700 illustrating a beam switch procedure. As illustrated in FIG. 7, a UE 702 may transmit a CSI report 701 to the base station 704. For monitoring active link performances, the UE 702 may perform measurements of at least one signal, e.g., reference signals, of one or more beams. The measurements may include deriving a metric similar to an Signal to Interference plus Noise Ratio (SINR) for the signal, or reference signal received power (RSRP) strength or a block error rate (BLER) of a reference control channel, e.g., based on an RRC configuration. The reference signal may include any of CSI-RS, Physical Broadcast Channel (PBCH), a synchronization signal, or other reference signals for time and/or frequency tracking, etc. In some cases, the UE may determine a configured metric such as block error rate (BLER) for a reference signal for the one or more beams. The measurement(s) may indicate the UE's ability to exchange communication with the base station 704 using the beam. In some aspects, the measurements may indicate that a current beam has a lower quality than a different beam. The UE 702 may indicate the different beam, e.g., as a new beam, to the base station 704. For example, the CSI report 701 may include a field representing a UE preferred beam that is different than a current beam. For example, the field representing the UE preferred beam may be a beam index. The reference signal indices in the CSI report 701 may be one-to-one mapped with a set of TCI states. In one example, the CSI report 701 may report multiple reference signal indices to the base station 704 so that the TCI states mapped to the reported reference signals may be activated without a TCI activation MAC CE. In another example, the CSI report 701 may report multiple reference signal indices to the base station 704 so that at least one of TCI states mapped to the reported reference signals can be indicated to its applicable channels without a TCI indication DCI. Based on the CSI report 701, the UE 702 and the base station 704 may perform beam switching, for downlink channels 705 and/or uplink channels 707. In some aspects, the base station 704 may also generate and transmit a beam indication 703. In some other aspects, the base station 704 may not transmit a beam indication 703. The beam switch performed for the downlink channels 705 and the uplink channels 707 may be independent of the beam indication 703. The beam switch performed may be either implicit TCI activation or implicit TCI indication based on the configuration for the CSI report 701.

In some aspects, a UE may request a dedicated CSI report (e.g., request to transmit a dedicated CSI report) for implicit beam switch based on RRC configuration. For example, a UE may request a dedicated CSI report for implicit beam switch based on RRC configuration using dedicated SR. For example, the dedicated SR may be one of scheduling request PUCCH (SR-PUCCH) for triggering a CSI report for an implicit beam switch. In another example, the UE may request the CSI report through a PRACH transmission for triggering a CSI report specific for implicit beam switch. The dedicated SR may be used for indicating the request for implicit beam switch. In some aspects, a UE may transmit CSI report for implicit beam switch based on a base station's scheduling after the SR. In another example, a UE use a set of dedicated PRACH resources for requesting the dedicated CSI report for beam switch. In some aspects, each PRACH resource in the set of dedicated PRACH resources may be associated with a RS or a TCI state for beam switch, such that the transmission of PRACH in a PRACH resource may indicate a corresponding RS or TCI state to the base station.

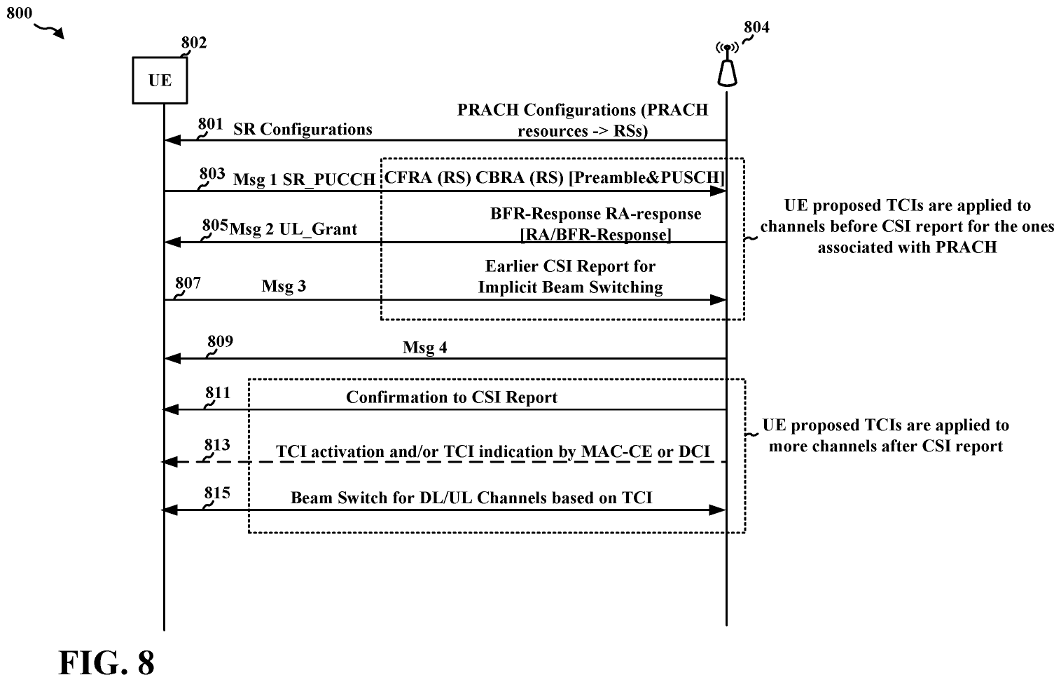

FIG. 8 is a diagram 800 illustrating a UE initiated CSI request procedure. A MAC entity of the UE 802 may be configured by RRC with a UE initiated CSI request procedure, which may be used for requesting a grant for transmitting a dedicated CSI report to the serving base station (such as the base station 804) for beam switch.

As illustrated in FIG. 8, the base station 804 may transmit a set of configurations 801 to the UE 802. In some aspects, the set of configurations 801 may be SR configurations. In some aspects, the set of configurations 801 may include a set of PRACH configurations. The set of PRACH configurations may include PRACH resources associated with (e.g., mapped to) RSs or TCI states. The set of configurations 801 may include, by way of example, one or more SR configurations that may each correspond to one or more logical channels. Each logical channel may be mapped to zero or one SR configuration, which may be configured by RRC. After receiving the set of configurations 801, the UE 802 may transmit a first message 803 (Msg 1). In some aspects, the first message 803 may be associated with an SR PUCCH. In some aspects, the first message 803 may be associated with (e.g., include or indicate) PRACH parameters such as CFRA preamble, CBRA preamble, or preamble and PUSCH in MsgA of PRACH, where each PRACH parameters/resource for the PRACH may be associated with a RS or a TCI state corresponding to a DL and/or UL beam. In some aspects, the first message 803 may be transmitted after detecting a beam switch event based on the dedicated CSI report configurations. The UE 802 may initiate the CSI request based on CFRA or CBRA. The base station 804 may transmit a second message 805 (Msg 2). In some aspects, the second message 805 may be associated with an UL grant or a DCI requesting the dedicated CSI report. In some aspects, the second message 805 may be associated with various beam failure and RA responses such as beam failure recover (BFR) response, RA response, or RA/BFR response. The UE 802 may transmit a third message (Msg 3) 807 associated to the base station 804. The third message 807 may include a dedicated CSI report for implicit beam switching. The dedicated CSI report may include a beam index for beam switching, which can be either for implicit TCI activation or implicit TCI indication. Compared with the example in FIG. 6, the CSI report is transmitted in the third message 807, which may be earlier than the CSI report 611. Based on the first message 803 in PRACH transmission, the UE indicated or proposed TCIs via PRACH transmission may be applied to those channels associated with PRACH before the CSI report is transmitted or before the implicit beam switch based on the CSI report takes effect.

The base station 804 may further transmit a fourth random access message 809, which may include DCI. In some aspects, the base station 804 may skip transmission of a TCI activation 813 and the UE 802 and the base station 804 may perform implicit beam switch at 815 for TCI activation based on the TCI indicated in the CSI report in the third message 807, when the CSI report is configured for TCI activation in beam switch. In some other aspects, the base station 804 may skip transmission of a TCI indication 813 and the UE 802 and the base station 804 may perform implicit beam switch at 815 for TCI indication based on the TCI indicated in the CSI report in the third message 807, when the CSI report is configured for TCI indication in beam switch. In some aspects, the base station 804 may transmit a confirmation 811 to the CSI report transmitted in the third message 807. In some aspects, the base station 804 may transmit a TCI activation or TCI indication 813 (the TCI may correspond with a TCI indicated in the CSI report for implicit beam switch in the third message 807) via MAC-CE or DCI to the UE 802. In some aspects, because the UE 802 may transmit using dedicated PRACH resources, where each PRACH resource in the dedicated PRACH resources may be associated with a RS/TCI state for implicit beam switch, the RS/TCI state associated with the PRACH resource may also be used for the beam switch at 815.

In some aspects, a UE may be configured with a set of PRACH occasions where the PRACH occasions may be one to one mapped with RSs/TCI states (which correspond with beams). For implicit beam switch to one TCI state (and associated beam), the UE may initiate the PRACH transmission in a corresponding occasion to indicate one mapped RS/TCI to the base station. A UE may report one or more preferred RSs/TCIs in random access Msg3 or MsgA PUSCH of the PRACH. In some aspects, preferred RSs/TCIs may be reported as MAC-CE. For example, one MAC-CE report may include one or more RS ID or TCI IDs, up to a configured maximum number. In some aspects, preferred RS ID or TCI IDs may be reported as a CSI report with fixed UCI payload. For example, one CSI report may include one or more RS IDs, up to a configured maximum number. A UE may be configured with a set of CSI measurement sources for evaluating the TCIs. The application time for the implicit beam switching based on the CSI report to take effect may start from X slots or X milliseconds (ms) after one of: 1) PRACH transmission, 2) response from the base station for PRACH transmission, 3) CSI report transmission, or 4) confirmation to the CSI report from the base station.

In some aspects, when the UE is configured to report the preferred RS ID or TCI IDs for implicit beam switch in a MAC-CE, UE may transmit the MAC-CE for any available uplink resources, such as dynamic granted PUSCH, configured granted PUSCH, Msg 3 PUSCH of PRACH, or Msg A PUSCH of PRACH. The UE may report metrics for the RSs or TCIs in the MAC-CE for implicit beam switch.

In some aspects, a UE may request the CSI report for implicit beam switching by dedicated scheduling request or PRACH resources. In some aspects, the CSI report may be used for implicit TCI indication. For example, when UE reports one RS in the CSI report, the unified TCI mapped/QCLed with the RS may be applied for unified TCI update to applicable channels without DCI indication after the CSI report. In another example, if the UE reports one RS in the CSI report, the unified TCI mapped/QCLed with the RS may be activated for further TCI indication without MAC-CE activation after the CSI report. In some aspects, after the CSI report, the applicable channels for implicit beam switching may depend on the type of TCI, e.g., uplink channels are applicable for implicit beam switch to UL TCI and downlink channels are applicable for implicit beam switch to DL TCI. For example, if there are multiple TCIs reported with the same set of applicable channels, the UE may select one of them to be applied with implicit beam switch, e.g., based on a first reported RS, an RS with a lowest TCI or TCI codepoint (CP) identifier (ID), or the like. In some aspects, in addition to the selected beam based on the report, a second best beam can be used implicitly when the selected beam fails. In some aspects, the TCI state associated with the beam switch may be a joint TCI, a DL TCI or UL TCI. For example, during PRACH procedure and before some time (the confirmation to the CSI report or before the TCI for the beam switch based on the CSI report takes effect), the base station and the UE may reset DL/UL beams to part of channels. For a PRACH transmission mapped or associated with a DL TCI, the UE may change the beam for multiple DL channels (PDCCH/PDSCH) applicable to the DL TCI based on the DL TCI, before some time (the confirmation to the CSI report or before the TCI for the beam switch based on the CSI report takes effect). For a PRACH transmission mapped or associated with an UL TCI state, the UE may change the beam for multiple UL channels (PUCCH/PUSCH) applicable to the UL TCI based on the UL TCI, before some time (the confirmation to the CSI report or before the TCI for the beam switch based on the CSI report takes effect). For a PRACH transmission mapped or associated with a joint TCI, the UE may change the beam for at least one DL channel and at least one UL channel applicable to the joint TCI based on the joint TCI, before some time (the confirmation to the CSI report or before the TCI for the beam switch based on the CSI report takes effect). During the PRACH procedure, the beam resetting, or beam change, may be applicable to 1) PRACH involved channels, or 2) all applicable channels to the associated TCI beyond PRACH involved channels.

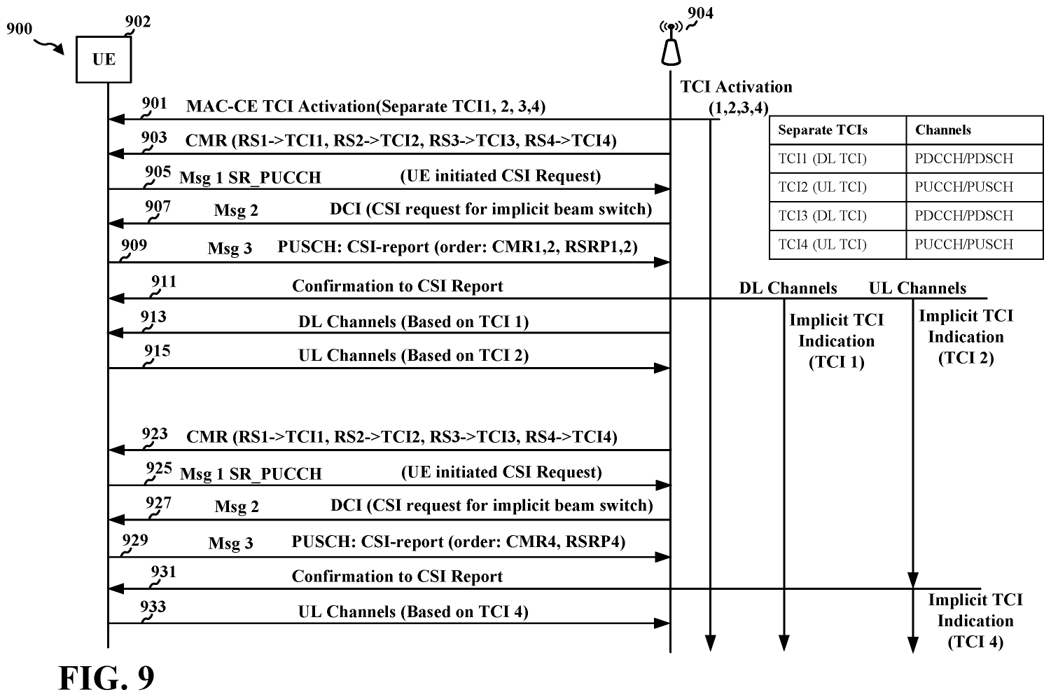

FIG. 9 is a diagram 900 illustrating a UE initiated CSI request procedure. As illustrated in FIG. 9, the base station 904 may transmit a MAC-CE TCI activation 901 to the UE 902. By way of example, the MAC-CE TCI activation 901 may activate four TCI states 1, 2, 3, and 4. The base station 904 may further transmit CMR 903 to the UE 902. The CMR 903 may include a mapping between RSs to TCI states. The UE 902 may transmit a first message 905 (Msg 1) to the base station 904 via an SR PUCCH. The first message 905 may include a UE initiated request for transmitting CSI report for implicit TCI indication. Based on the first message 905, the base station 904 may transmit a second message 907 (Msg 2) including a DCI confirming the CSI request for implicit beam switch. The DCI may schedule a PUSCH for transmitting the CSI report. The UE 902 may accordingly transmit a third message 909 (Msg 3) including a CSI report via the PUSCH. The CSI report may indicate CMRs and RSRPs. In some aspects, the base station 904 may transmit a confirmation 911 to the CSI report in the third message 909. In some aspects, the base station 904 may skip transmission of the confirmation 911. The UE 902 and the base station 904 may perform beam switch on DL channels 913 and UL channels 915 based on the CSI report in the third message 909. For example, based on the CSI report in the third message 909, the UE 902 and the base station 904 may perform beam switch for DL channels 913 based on a TCI state 1 and perform beam switch for UL channels 915 based on a TCI state 2.

As another example, in some aspects, the base station 904 may transmit a CMR 923 to the UE 902. The CMR 923 may include a mapping between RSs to TCI states. The UE 902 may transmit a first message 925 (Msg 1) to the base station 904 via an SR PUCCH. The first message 925 may include a UE initiated request for transmitting CSI report for implicit TCI indication. Based on the first message 925, the base station 904 may transmit a second message 927 (Msg 2) including a DCI confirming the CSI request for implicit beam switch. The DCI may schedule a PUSCH for transmitting the CSI report. The UE 902 may accordingly transmit a third message 929 (Msg 3) including a CSI report via the PUSCH. The CSI report may indicate CMRs and RSRPs. In some aspects, the base station 904 may transmit a confirmation 931 to the CSI report in the third message 929. In some aspects, the base station 904 may skip transmission of the confirmation 931. The UE 902 and the base station 904 may perform beam switch on UL channels 933 based on the CSI report in the third message 929. For example, based on the CSI report in the third message 929, the UE 902 and the base station 904 may perform beam switch for UL channels 933 based on a TCI state 4.

In some aspects, the UE may request the CSI report by dedicated scheduling request or PRACH resources, and the CSI report may be configured to report RSs or TCIs. For example, the CSI report may be configured to report RSs associated with DL TCI states, and the CSI report may include corresponding DL metrics. In some aspects, the CSI report may be configured to report RSs associated with UL TCI states, and the CSI report may include corresponding UL metrics. In some aspects, the CSI report may be configured to report RSs associated with joint TCI states, and the CSI report may include corresponding DL and UL metrics. In some aspects, a maximum number of TCI states for each type may be configured. In some aspects, The DL metrics may include L1-RSRP, L1-SINR, and UL metrics may include modified power headroom (PHR), a power management maximum power reduction (P-MPR), a maximum permissible exposure (MPE), or UL RSRP. The dedicated CSI report for implicit beam switch may be reported in a MAC-CE.

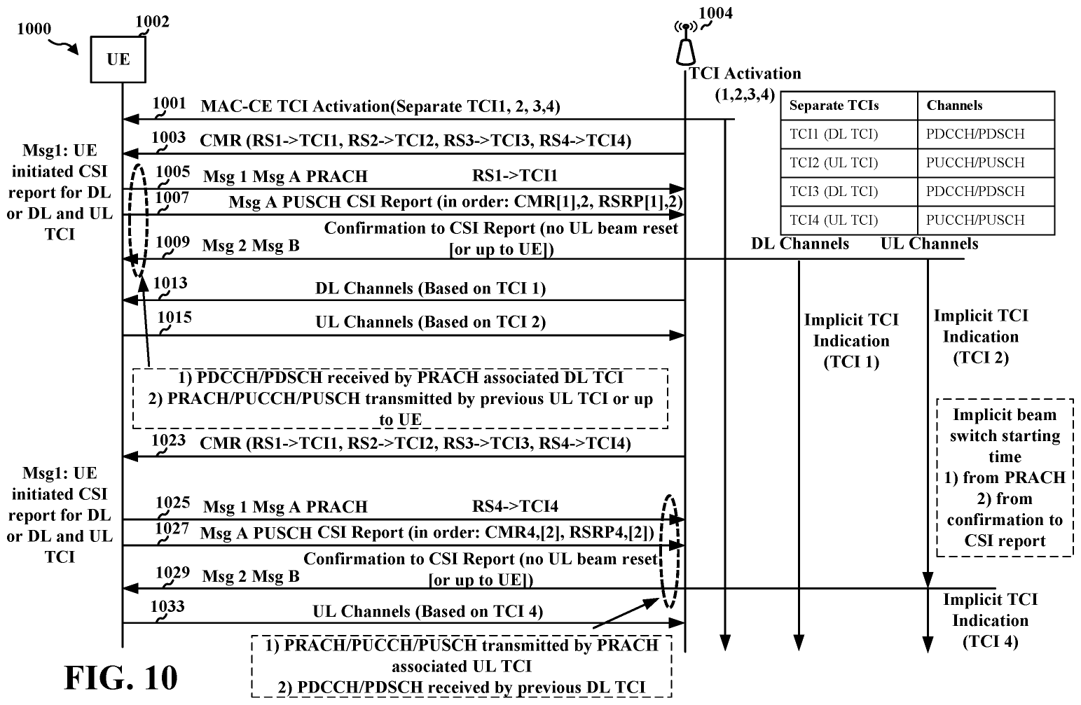

FIG. 10 is a diagram 1000 illustrating a UE initiated CSI request procedure based on two-step PRACH. As illustrated in FIG. 10, the base station 1004 may transmit a MAC-CE TCI activation 1001 to the UE 1002. By way of example, the MAC-CE TCI activation 1001 may activate four TCI states 1, 2, 3, and 4. The base station 1004 may further transmit CMR 1003 to the UE 1002. The CMR 1003 may include a mapping between RSs to TCI states. The UE 1002 may transmit a first message 1005 (Msg 1 or Msg A) to the base station 1004 via PRACH. The first message 1005 may include a UE initiated request for transmitting CSI report. The UE 1002 may further transmit a message 1007 (Msg A) which may include a CSI report via PUSCH of Msg A. The CSI report in the message 1007 may include CMR or RSRP and may indicate a DL beam.

Based on the message 1007, the base station 1004 may transmit a second message 1009 (Msg 2) including a confirmation for the request for implicit beam switch associated with the CSI report in the message 1007. The UE 1002 and the base station 1004 may perform beam switch on DL channels 1013 and UL channels 1015 based on the CSI report in the message 1007. For example, based on the CSI report in the message 1007, the UE 1002 and the base station 1004 may perform beam switch for DL channels 1013 based on a TCI state 1 and perform beam switch for UL channels 1015 based on a TCI state 2. In some aspects, in the PRACH procedure, DL channels 1013 (which may include PDCCH/PDSCH) may be based on DL TCI associated with PRACH transmission (in the message 1005), and the UL channels 1015 may be based on PRACH/PUCCH/PUSCH transmitted by previous UL TCI or up to UE 1002.

As another example, in some aspects, the base station 1004 may transmit a CMR 1023 to the UE 1002. The CMR 1023 may include a mapping between RSs to TCI states. The UE 1002 may transmit a first message 1025 (Msg 1, Msg A) to the base station 1004 via PRACH. The first message 1025 may include a UE initiated request for transmitting CSI report for implicit TCI indication. The UE 1002 may further transmit a message 1027 (Msg A) which may include a CSI report via PUSCH of Msg A. The CSI report in the message 1007 may include CMR or RSRP and may indicate a UL beam.

The base station 1004 may transmit a second message 1029 (Msg 2, Msg B) including a confirmation for the implicit beam switch. The UE 1002 and the base station 1004 may accordingly perform beam switch on UL channels 1033 based on the CSI report in the message 1027. For example, based on the CSI report in the message 1027, the UE 1002 and the base station 1004 may perform beam switch for UL channels 1033 based on a TCI state 4. In some aspects, during the PRACH procedure, DL channels (which may include PDCCH/PDSCH) may be based on previous DL TCI, and the UL channels 1033 (which may PRACH/PUCCH/PUSCH) may be based on UL TCI associated with the PRACH (e.g., in the message 1025).

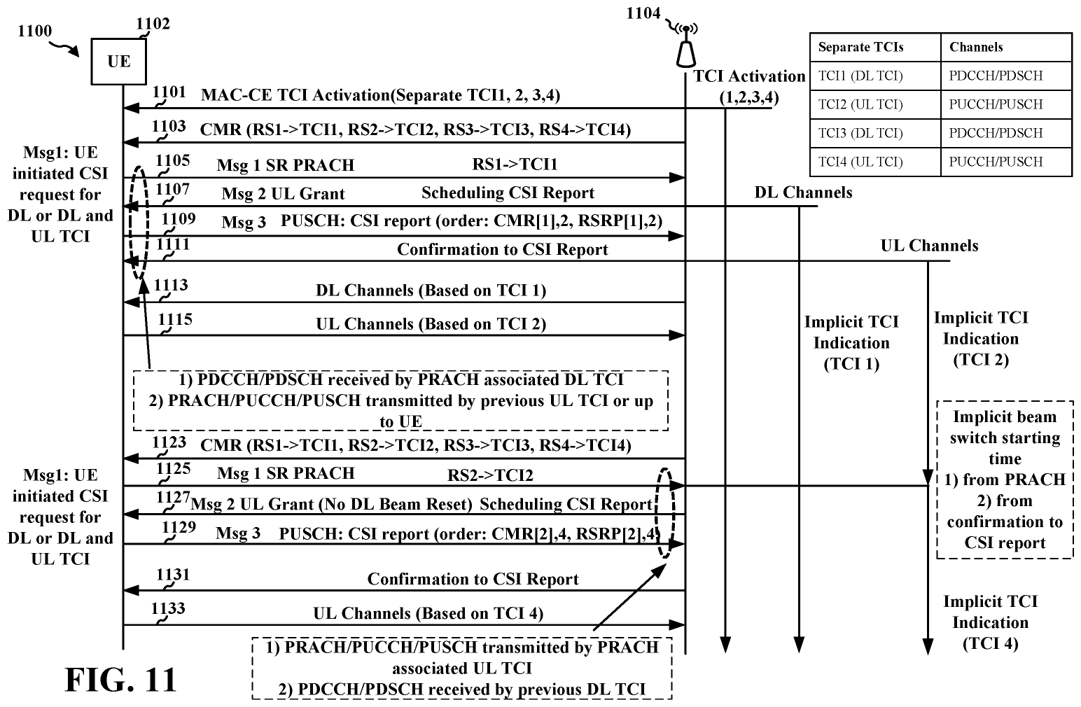

FIG. 11 is a diagram 1100 illustrating a UE initiated CSI request procedure. As illustrated in FIG. 11, the base station 1104 may transmit a MAC-CE TCI activation 1101 to the UE 1102. By way of example, the MAC-CE TCI activation 1101 may activate four TCI states 1, 2, 3, and 4. The base station 1104 may further transmit CMR 1103 to the UE 1102. The CMR 1103 may include a mapping between RSs to TCI states. The UE 1102 may transmit a first message 1105 (Msg 1) to the base station 1104 via an PRACH for scheduling request. The first message 1105 may include a UE initiated request for transmitting CSI report for implicit TCI indication. Based on the first message 1105, the base station 1104 may transmit a second message 1107 (Msg 2) including a UL grant scheduling a PUSCH for transmitting the CSI report. The UE 1102 may accordingly transmit a third message 1109 (Msg 3) including a CSI report via the PUSCH. The CSI report may indicate CMRs and RSRPs. In some aspects, the base station 1104 may transmit a confirmation 1111 to the CSI report in the third message 1109. In some aspects, the base station 1104 may skip transmission of the confirmation 1111. The UE 1102 and the base station 1104 may perform beam switch on DL channels 1113 and UL channels 1115 based on the CSI report in the third message 1109. For example, based on the CSI report in the third message 1109, the UE 1102 and the base station 1104 may perform beam switch for DL channels 1113 based on a TCI state 1 and perform beam switch for UL channels 1115 based on a TCI state 2. In some aspects, during the PRACH procedure, DL channels 1113 (which may include PDCCH/PDSCH) may be based on DL TCI received via PRACH (in the message 1109), and the UL channels 1115 may be based on PRACH/PUCCH/PUSCH transmitted by previous UL TCI or up to UE 1102.

As another example, in some aspects, the base station 1104 may transmit a CMR 1123 to the UE 1102. The CMR 1123 may include a mapping between RSs to TCI states. The UE 1102 may transmit a first message 1125 (Msg 1) to the base station 1104 via PRACH. The first message 1125 may include a UE initiated request for transmitting CSI report. Based on the first message 1125, the base station 1104 may transmit a second message 1127 (Msg 2) including a UL grant scheduling a PUSCH for transmitting the CSI report. The UE 1102 may accordingly transmit a third message 1129 (Msg 3) including a CSI report via the PUSCH. The CSI report may indicate CMRs and RSRPs. In some aspects, the base station 1104 may transmit a confirmation 1131 to the CSI report in the third message 1129. In some aspects, the base station 1104 may skip transmission of the confirmation 1131. The UE 1102 and the base station 1104 may perform beam switch on UL channels 1133 based on the CSI report in the third message 1129. For example, based on the CSI report in the third message 1129, the UE 1102 and the base station 1104 may perform beam switch for UL channels 1133 based on a TCI state 4. In some aspects, during the PRACH procedure, DL channels (which may include PDCCH/PDSCH) may be based on previous DL TCI or up to the UE, and the UL channels 1133 (which may PRACH/PUCCH/PUSCH) may be based on UL TCI associated with the PRACH (e.g., in the message 1125).

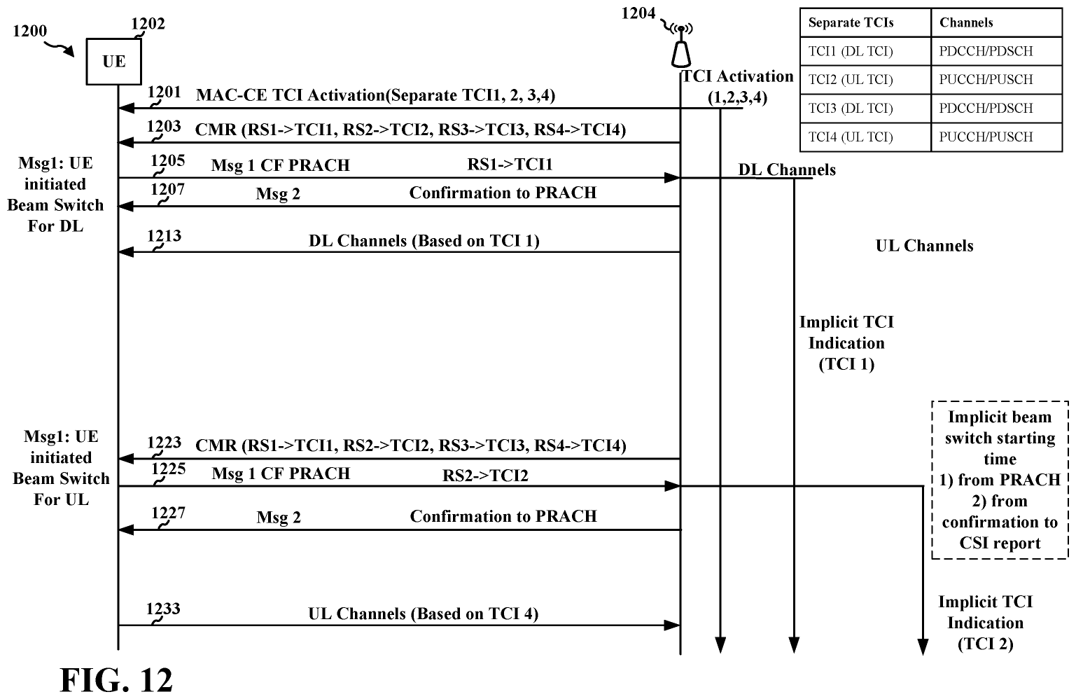

FIG. 12 is a diagram 1200 illustrating a UE initiated CSI request procedure based on contention free PRACH (CF RACH). As illustrated in FIG. 12, the base station 1204 may transmit a MAC-CE TCI activation 1201 to the UE 1202. By way of example, the MAC-CE TCI activation 1201 may activate four TCI states 1, 2, 3, and 4. The base station 1204 may further transmit CMR 1203 to the UE 1202. The CMR 1203 may include a mapping between RSs to TCI states. The UE 1202 may transmit a first message 1205 (Msg 1) to the base station 1204 via CF PRACH. Resources in the CF PRACH may be one-to-one mapped to the TCI states activated by 1201. Based on receiving the first message 1205 via CF PRACH, the base station 1204 may be aware that the UE 1202 is requesting an implicit beam switch. The base station 1204 may accordingly transmit a second message 1207 for confirmation. The UE 1202 and the base station 1204 may accordingly perform beam switch on DL channels 1213 as the TCI state associated with the CF PRACH. For example, the transmitted CF PRACH may be mapped to a TCI state 1 and the UE 1202 and the base station 1204 may accordingly perform beam switch on DL channels 1213 based on TCI state 1.

As another example, the base station 1204 may further transmit CMR 1223 to the UE 1202. The CMR 1203 may include a mapping between RSs to TCI states. The UE 1202 may transmit a first message 1225 (Msg 1 or Msg A) to the base station 1204 via CF PRACH. Resources in the CF PRACH may be mapped to TCI states. Based on receiving the first message 1225 via CF PRACH, the base station 1204 may be aware that the UE 1202 is requesting an implicit beam switch. The base station 1204 may accordingly transmit a second message 1227 for confirmation. The UE 1202 and the base station 1204 may accordingly perform beam switch on UL channels 1233. For example, the CF PRACH may be mapped to a TCI state 4 and the UE 1202 and the base station 1204 may accordingly perform beam switch on UL channels 1233 based on TCI state 4.

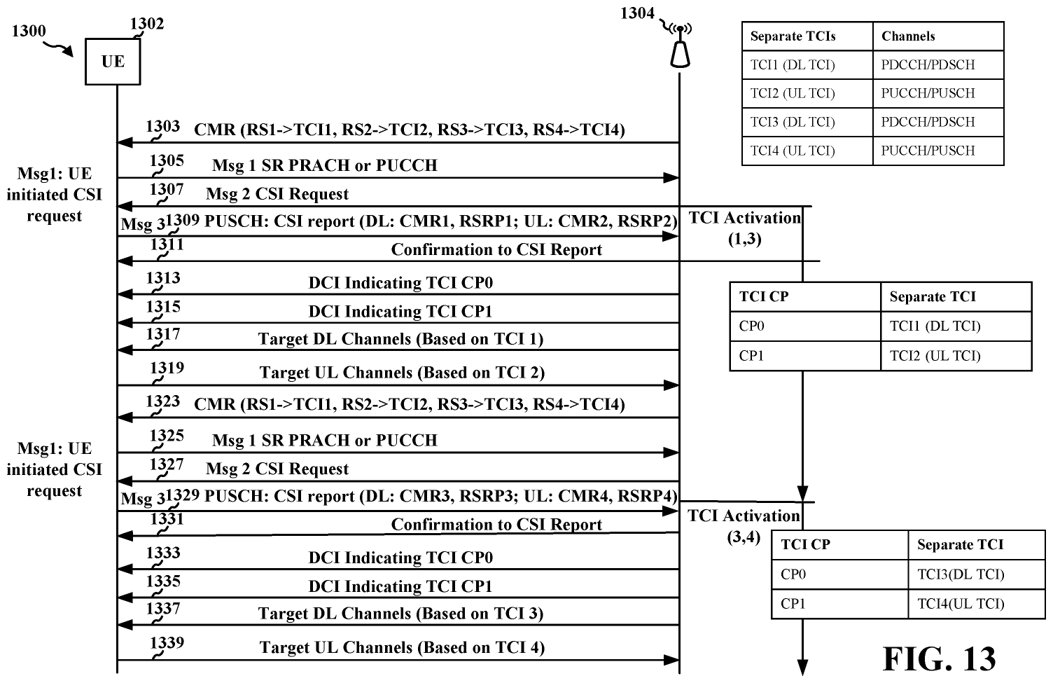

FIG. 13 is a diagram 1300 illustrating a UE initiated CSI request procedure. The base station 1304 may transmit CMR 1303 to the UE 1302. The CMR 1303 may include a mapping between RSs to TCI states. The UE 1302 may transmit a first message 1305 (Msg 1) to the base station 1304 via an SR PRACH or PUCCH. The first message 1305 may include a UE initiated request for transmitting CSI report for implicit TCI activation. Based on the first message 1305, the base station 1304 may transmit a second message 1307 (Msg 2) scheduling a PUSCH for transmitting the CSI report. The UE 1302 may accordingly transmit a third message 1309 (Msg 3) including a CSI report via the PUSCH. The CSI report may indicate CMRs and RSRPs. In some aspects, the base station 1304 may transmit a confirmation 1311 to the CSI report in the third message 1309. In some aspects, the base station 1304 may skip transmission of the confirmation 1311. In some aspects, the base station may further transmit a DCI 1313 indicating TCI for CP 0 and/or a DCI 1315 for indicating TCI CP1. Based on the CSI report for implicit TCI activation, the TCI for CP 0 is TCI1 and the TCI for CP1 is TCI2. The UE 1302 and the base station 1304 may perform beam switch on target DL channels 1317 and target UL channels 1319 based on the TCI activated by the CSI report in the third message 1309. For example, the beam switch on the target DL channels 1317 indicated by DCI 1313 may be based on a TCI state 1 based on the CSI report in the third message 1309. The beam switch on the target UL channels 1319 indicated by DCI 1313 may be based on a TCI state 2 based on the CSI report in the third message 1309.

As another example, the base station 1304 may transmit CMR 1323 to the UE 1302. The CMR 1323 may include a mapping between RSs to TCI states. The UE 1302 may transmit a first message 1325 (Msg 1) to the base station 1304 via an SR PRACH or PUCCH. The first message 1325 may include a UE initiated request for transmitting CSI report for implicit TCI activation. Based on the first message 1325, the base station 1304 may transmit a second message 1327 (Msg 2) scheduling a PUSCH for transmitting the CSI report. The UE 1302 may accordingly transmit a third message 1329 (Msg 3) including a CSI report via the PUSCH. The CSI report may indicate CMRs and RSRPs. In some aspects, the base station 1304 may transmit a confirmation 1331 to the CSI report in the third message 1329. In some aspects, the base station 1304 may skip transmission of the confirmation 1331. In some aspects, the base station may further transmit a DCI 1333 indicating TCI for CP 0 and/or a DCI 1335 for indicating TCI CP1. Based on the CSI report for implicit TCI activation, the TCI for CP 0 is TCI3 and the TCI for CP1 is TCI4. The UE 1302 and the base station 1304 may perform beam switch on target DL channels 1337 and target UL channels 1339 based on the CSI report in the third message 1329. For example, the beam switch on the target DL channels 1337 indicated by DCI 1333 may be based on a TCI state 3 based on the CSI report in the third message 1329. The beam switch on the target UL channels 1339 indicated by DCI 1335 may be based on a TCI state 4 based on the CSI report in the third message 1329.

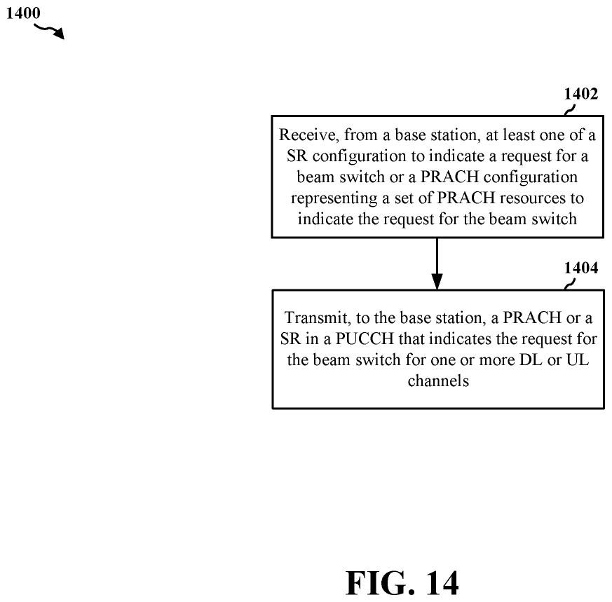

FIG. 14 is a flowchart 1400 of a method of wireless communication. The method may be performed by a UE (e.g., the UE 104, 802, 902, 1002, 1102, 1202, 1302, other UEs; the apparatus 1802). The method may be used for improving beam switch efficiency.

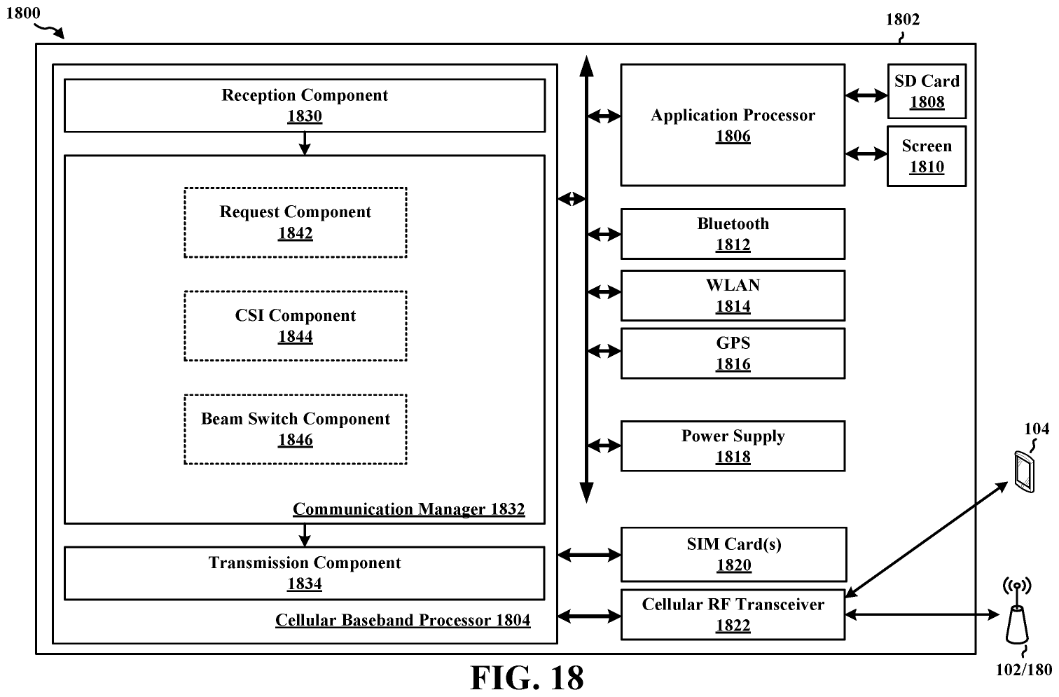

At 1402, the UE may receive, from a base station, at least one of an SR configuration to indicate a request for a beam switch or a PRACH configuration representing a set of PRACH resources to indicate the request for the beam switch. For example, the UE 802 may receive, from a base station 804, at least one of an SR configuration to indicate a request for a beam switch or a PRACH configuration representing a set of PRACH resources to indicate the request for the beam switch in the set of configurations 801. In some aspects, 1402 may be performed by request component 1842 of FIG. 18.

At 1404, the UE may transmit, to the base station, a PRACH or an SR in a PUCCH that indicates the request for the beam switch for one or more DL or UL channels. For example, the UE 802 may transmit, to the base station 804, a PRACH or an SR in a PUCCH that indicates the request for the beam switch in the first message 803 for one or more DL or UL channels. In some aspects, 1402 may be performed by request component 1842 of FIG. 18.

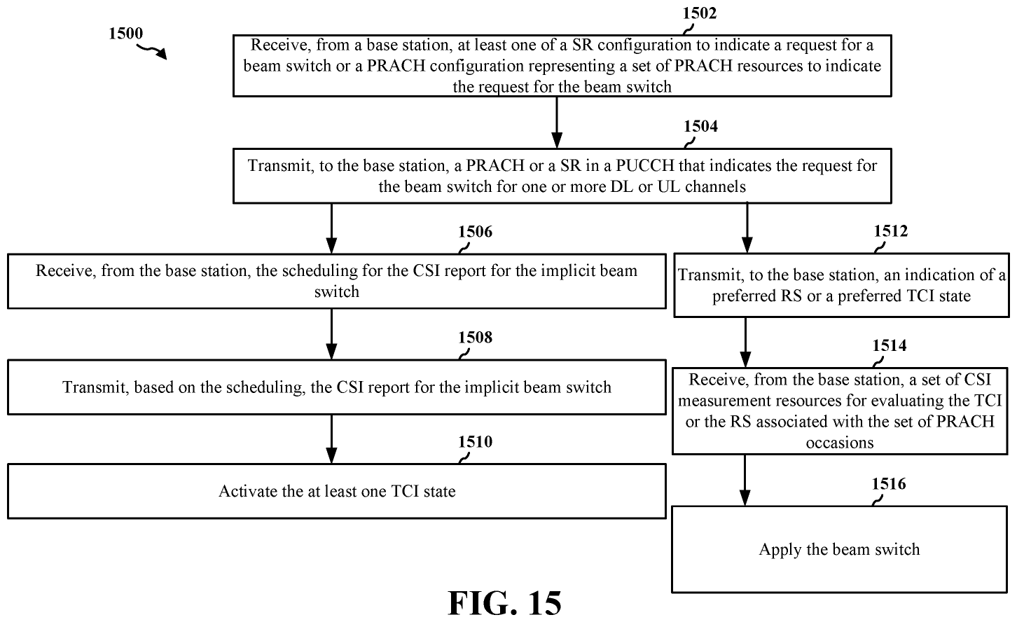

FIG. 15 is a flowchart 1500 of a method of wireless communication. The method may be performed by a UE (e.g., the UE 104, 802, 902, 1002, 1102, 1202, 1302, other UEs; the apparatus 1802). The method may be used for improving beam switch efficiency.

At 1502, the UE may receive, from a base station, at least one of an SR configuration to indicate a request for a beam switch or a PRACH configuration representing a set of PRACH resources to indicate the request for the beam switch. For example, the UE 802 may receive, from a base station 804, at least one of an SR configuration to indicate a request for a beam switch or a PRACH configuration representing a set of PRACH resources to indicate the request for the beam switch in the set of configurations 801. In some aspects, 1502 may be performed by request component 1842 of FIG. 18.

At 1504, the UE may transmit, to the base station, a PRACH or an SR in a PUCCH that indicates the request for the beam switch for one or more DL or UL channels. For example, the UE 802 may transmit, to the base station 804, a PRACH or an SR in a PUCCH that indicates the request for the beam switch in the first message 803 for one or more DL or UL channels. In some aspects, 1402 may be performed by request component 1842 of FIG. 18. In some aspects, the request for the beam switch corresponds to a request for an implicit beam switch based on a CSI report, the request may be based on a RRC configuration. In some aspects, the UE may transmit the SR in the PUCCH to request a CSI report associated with an implicit beam switch. In some aspects, the UE may transmit the PRACH in a resource in the set of PRACH resources configured to indicate an implicit beam switch. In some aspects, the PRACH resource may be associated with a TCI state or a RS for the implicit beam switch. In some aspects, each PRACH occasion in the set of PRACH resources is associated with a TCI or a RS among one or more RSs or TCIs for the implicit beam switch.

In some aspects, at 1506, the UE may receive, from the base station, the scheduling for the CSI report for the implicit beam switch. For example, the UE 802 may receive, from the base station 804, the scheduling for the CSI report for the implicit beam switch in the second message 805. In some aspects, 1506 may be performed by CSI component 1844 of FIG. 18.

In some aspects, at 1508, the UE may transmit, based on the scheduling, the CSI report for the implicit beam switch. For example, the UE 802 may transmit, based on the scheduling, the CSI report for the implicit beam switch in the third message 807. In some aspects, 1508 may be performed by the CSI component 1844 of FIG. 18. In some aspects, the UE indicates at least one RS in the CSI report. In some aspects, the implicit beam switch is associated with a beam having a QCL relationship between the at least one RS and at least one TCI state.

In some aspects, at 1510, the UE may accordingly activate the at least one TCI state and perform the beam switch. In some aspects, 1510 may be performed beam switch component 1846 of FIG. 18. In some aspects, the UE indicates at least one RS in the CSI report, the implicit beam switch may be associated with a beam having a QCL relationship between the at least one RS and at least one TCI state. The UE may activate the at least one TCI state independent of a MAC-CE indication at 1510. In some aspects, the beam switch is applied to the one or more DL or UL channels based on a type of a TCI associated with the at least one RS. In some aspects, the beam switch is applied to the one or more DL or UL channels further based on one or more of: an order associated with the at least one RS, a TCI ID, or a TCI CP ID. In some aspects, at least one TCI associated with the at least one RS includes one or more of: a DL TCI for multiple downlink channels, an UL TCI for multiple uplink channels, or a joint TCI for a combination of uplink and downlink channels. In some aspects, the implicit beam switch applies to multiple channels associated with a PRACH procedure. In some aspects, the implicit beam switch is based on the CSI report for the implicit beam switch. In some aspects, the CSI report may include one or more DL TCI states. In some aspects, the CSI report may include one or more UL TCI states. In some aspects, the CSI report may include one or more joint TCI states or a combination of UL and DL TCI states. In some aspects, the corresponding metrics may include one or more of: a RSRP, an SINR, a PHR, a P-MPR, a MPE, or the like.

In some aspects, at 1512, the UE may transmit, to the base station, an indication of a preferred RS or a preferred TCI state. For example, the UE 1002 may transmit, to the base station 1004, an indication of a preferred RS or a preferred TCI state. In some aspects, the indication may be included in a random access Msg 3 or a random access Msg A PUSCH. In some aspects, the indication may be included in a MAC-CE. In some aspects, the indication may be included in a CSI report. In some aspects, the CSI report may be associated with a fixed UCI payload with a configured maximum number associated with the one or more RSs or TCIs. In some aspects, at 1514, the UE may receive, from the base station, a set of CSI measurement resources for evaluating the TCI or the RS associated with the set of PRACH occasions. In some aspects, 1514 may be performed by the CSI component 1844. In some aspects, at 1516, the UE may apply the beam switch. The beam switch may be applied based on a time based on one or more of: a PRACH transmission associated with the beam switch, a response from the base station for the PRACH transmission, a CSI report transmission associated with the beam switch, or a confirmation of the CSI report transmission associated with the beam switch from the base station.

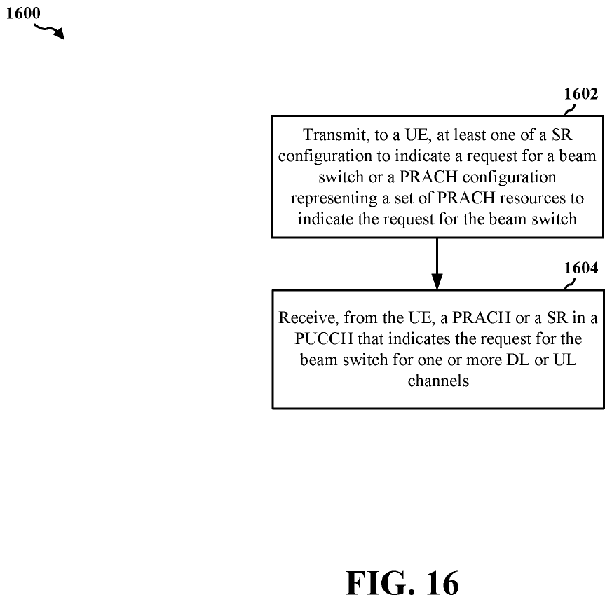

FIG. 16 is a flowchart 1600 of a method of wireless communication. The method may be performed by a base station (e.g., the base station 102/190, 804, 904, 1004, 1104, 1204, 1304, other base stations; the apparatus 1902). The method may be used for improving beam switch efficiency.

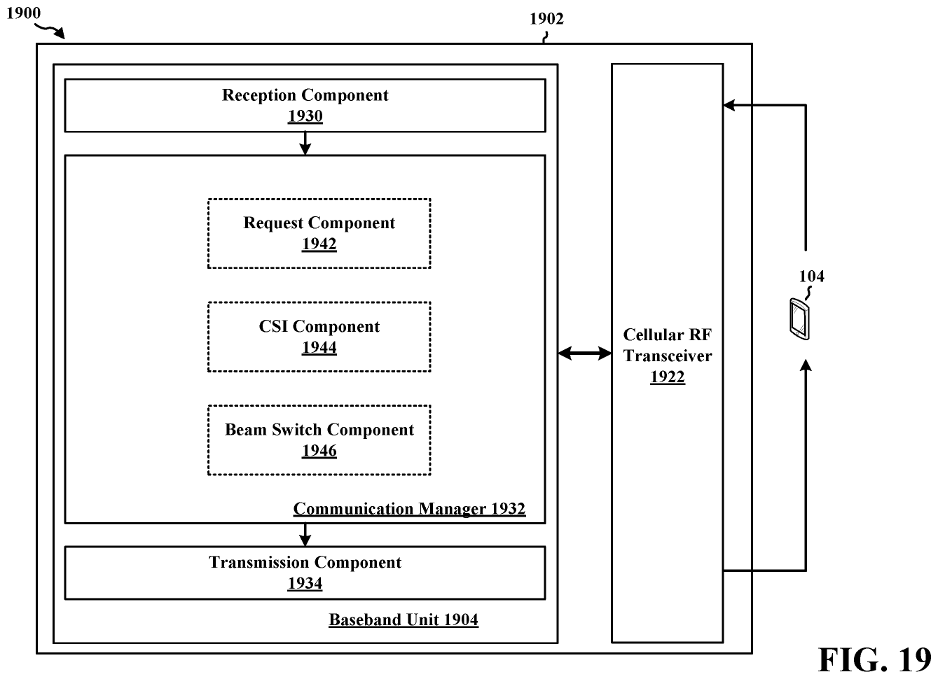

At 1602, the base station may transmit, to a UE, at least one of an SR configuration to indicate a request for a beam switch or a PRACH configuration representing a set of PRACH resources to indicate the request for the beam switch. For example, the base station 804 may transmit, to a UE 802, at least one of an SR configuration to indicate a request for a beam switch or a PRACH configuration representing a set of PRACH resources to indicate the request for the beam switch in the set of configurations 801. In some aspects, 1602 may be performed by request component 1942 of FIG. 19.

At 1604, the base station may receive, from the UE, a PRACH or an SR in a PUCCH that indicates the request for the beam switch for one or more DL or UL channels. For example, the base station 804 may receive, from the UE 802, a PRACH or an SR in a PUCCH that indicates the request for the beam switch in the first message 803 for one or more DL or UL channels. In some aspects, 1602 may be performed by request component 1942 of FIG. 19.

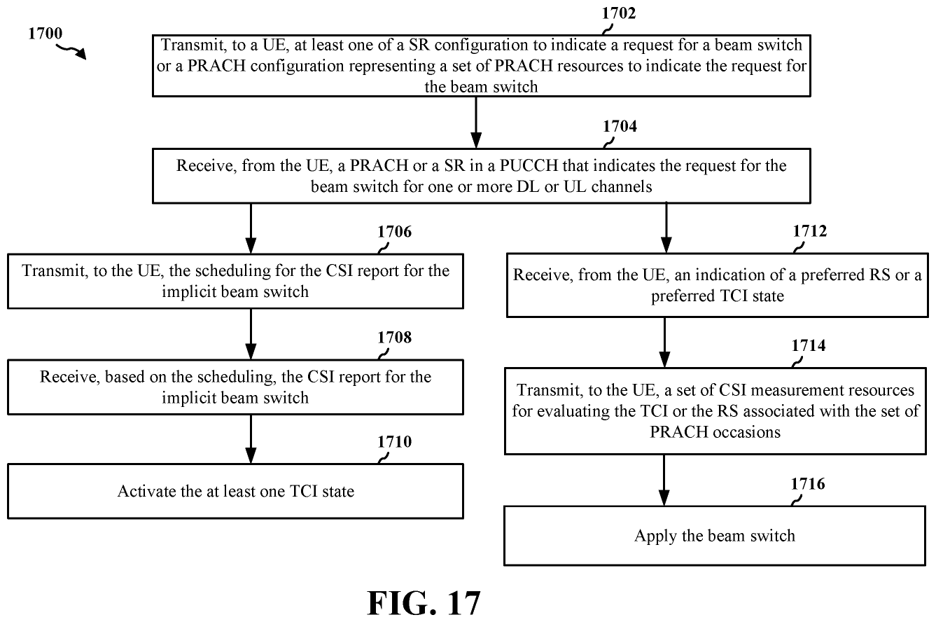

FIG. 17 is a flowchart 1700 of a method of wireless communication. The method may be performed by a base station (e.g., the base station 102/190, 804, 904, 1004, 1104, 1204, 1304, other base stations; the apparatus 1902). The method may be used for improving beam switch efficiency.

At 1702, the base station may transmit, to a UE, at least one of an SR configuration to indicate a request for a beam switch or a PRACH configuration representing a set of PRACH resources to indicate the request for the beam switch. For example, the base station 804 may transmit, to a UE 802, at least one of an SR configuration to indicate a request for a beam switch or a PRACH configuration representing a set of PRACH resources to indicate the request for the beam switch in the set of configurations 801. In some aspects, 1702 may be performed by request component 1942 of FIG. 19.

At 1704, the base station may receive, from the UE, a PRACH or an SR in a PUCCH that indicates the request for the beam switch for one or more DL or UL channels. For example, the base station 804 may receive, from the UE 802, a PRACH or an SR in a PUCCH that indicates the request for the beam switch in the first message 803 for one or more DL or UL channels. In some aspects, 1602 may be performed by request component 1942 of FIG. 19. In some aspects, the request for the beam switch corresponds to a request for an implicit beam switch based on a CSI report, the request may be based on a RRC configuration. In some aspects, the base station may receive the SR in the PUCCH to request a CSI report associated with an implicit beam switch. In some aspects, the base station may receive the PRACH in a resource in the set of PRACH resources configured to indicate an implicit beam switch. In some aspects, the PRACH resource may be associated with a TCI state or a RS for the implicit beam switch. In some aspects, each PRACH occasion in the set of PRACH resources is associated with a TCI or a RS among one or more RSs or TCIs for the implicit beam switch.

In some aspects, at 1706, the base station may transmit, to the UE, the scheduling for the CSI report for the implicit beam switch. For example, the base station 804 may transmit, to the UE 802, the scheduling for the CSI report for the implicit beam switch in the second message 805. In some aspects, 1706 may be performed by CSI component 1944 of FIG. 19.

In some aspects, at 1708, the base station may receive, based on the scheduling, the CSI report for the implicit beam switch. For example, the base station 804 may receive, based on the scheduling, the CSI report for the implicit beam switch in the third message 807. In some aspects, 1708 may be performed by the CSI component 1944 of FIG. 19. In some aspects, the implicit beam switch is associated with a beam having a QCL relationship between the at least one RS and at least one TCI state.

In some aspects, at 1710, the base station may accordingly activate the at least one TCI state and perform the beam switch. In some aspects, 1710 may be performed beam switch component 1946 of FIG. 19. In some aspects, the base station may receive an indication that indicates at least one RS in the CSI report, the implicit beam switch may be associated with a beam having a QCL relationship between the at least one RS and at least one TCI state. The UE may activate the at least one TCI state independent of a MAC-CE indication at 1710. In some aspects, the beam switch is applied to the one or more DL or UL channels based on a type of a TCI associated with the at least one RS. In some aspects, the beam switch is applied to the one or more DL or UL channels further based on one or more of: an order associated with the at least one RS, a TCI ID, or a TCI CP ID. In some aspects, at least one TCI associated with the at least one RS includes one or more of: a DL TCI for multiple downlink channels, an UL TCI for multiple uplink channels, or a joint TCI for a combination of uplink and downlink channels. In some aspects, the implicit beam switch applies to multiple channels associated with a PRACH procedure. In some aspects, the implicit beam switch is based on the CSI report for the implicit beam switch. In some aspects, the CSI report may include one or more DL TCI states. In some aspects, the CSI report may include one or more UL TCI states. In some aspects, the CSI report may include one or more joint TCI states or a combination of UL and DL TCI states. In some aspects, the corresponding metrics may include one or more of: a RSRP, an SINR, a PHR, a P-MPR, a MPE, or the like.

In some aspects, at 1712, the base station may receive, from the UE, an indication of a preferred RS or a preferred TCI state. For example, the base station 1004 may receive, from the UE 1002 an indication of a preferred RS or a preferred TCI state. In some aspects, the indication may be included in a random access Msg 3 or a random access Msg A PUSCH. In some aspects, the indication may be included in a MAC-CE. In some aspects, the indication may be included in a CSI report. In some aspects, the CSI report may be associated with a fixed UCI payload with a configured maximum number associated with the one or more RSs or TCIs. In some aspects, at 1714, the base station may transmit, to the UE, a set of CSI measurement resources for evaluating the TCI or the RS associated with the set of PRACH occasions. In some aspects, 1714 may be performed by the CSI component 1944. In some aspects, at 1716, the base station may apply the beam switch. The beam switch may be applied based on a time based on one or more of: a PRACH transmission associated with the beam switch, a response from the base station for the PRACH transmission, a CSI report transmission associated with the beam switch, or a confirmation of the CSI report transmission associated with the beam switch from the base station.

FIG. 18 is a diagram 1800 illustrating an example of a hardware implementation for an apparatus 1802. The apparatus 1802 may be a UE, a component of a UE, or may implement UE functionality. In some aspects, the apparatus 1802 may include a cellular baseband processor 1804 (also referred to as a modem) coupled to a cellular RF transceiver 1822. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The cellular baseband processor 1804 communicates through the cellular RF transceiver 1822 with the UE 104 and/or BS 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the UE 350 and may include the memory 360 and/or at least one of the TX processor 368, the RX processor 356, and the controller/processor 359. In one configuration, the apparatus 1802 may be a modem chip and include just the cellular baseband processor 1804, and in another configuration, the apparatus 1802 may be the entire UE (e.g., see 350 of FIG. 3) and include the additional modules of the apparatus 1802.

The communication manager 1832 may include a request component 1842 that is configured to receive, from a base station, at least one of an SR configuration to indicate a request for a beam switch or a PRACH configuration representing a set of PRACH resources to indicate the request for the beam switch and transmit, to the base station, a PRACH or an SR in a PUCCH that indicates the request for the beam switch for one or more DL or UL channels, e.g., as described in connection with 1402, 1404, 1502, and 1504. The communication manager 1832 may further include a CSI component 1844 that may be configured to receive, from the base station, the scheduling for the CSI report for the implicit beam switch, transmit, based on the scheduling, the CSI report for the implicit beam switch, transmit, to the base station, an indication of a preferred RS or a preferred TCI state, and receive, from the base station, a set of CSI measurement resources for evaluating the TCI or the RS associated with the set of PRACH occasions, e.g., as described in connection with 1506, 1508, 1512, and 1514. The communication manager 1832 may further include a beam switch component 1846 that may be configured to activate the at least one TCI state and apply the beam switch, e.g., as described in connection with 1510 and 1516.

The apparatus may include additional components that perform each of the blocks of the algorithm in the flowcharts of FIGS. 14 and 15. As such, each block in the flowcharts of FIGS. 14 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the cellular baseband processor 1804, may include means for receiving, from a base station, at least one of an SR configuration to indicate a request for a beam switch or a PRACH configuration representing a set of PRACH resources to indicate the request for the beam switch. The cellular baseband processor 1804 may further include means for transmitting, to the base station, a PRACH or an SR in a PUCCH that indicates the request for the beam switch for one or more DL or UL channels. The cellular baseband processor 1804 may further include means for receiving, from the base station, the scheduling for the CSI report for the implicit beam switch. The cellular baseband processor 1804 may further include means for transmitting, based on the scheduling, the CSI report for the implicit beam switch. The cellular baseband processor 1804 may further include means for activating the at least one TCI state. The cellular baseband processor 1804 may further include means for transmitting, to the base station, an indication of a preferred RS or a preferred TCI state. The cellular baseband processor 1804 may further include means for receiving, from the base station, a set of CSI measurement resources for evaluating the TCI or the RS associated with the set of PRACH occasions. The cellular baseband processor 1804 may further include means for applying the beam switch. The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 19 is a diagram 1900 illustrating an example of a hardware implementation for an apparatus 1902. The apparatus 1902 may be a base station, a component of a base station, or may implement base station functionality. In some aspects, the apparatus 1802 may include a baseband unit 1904. The baseband unit 1904 may communicate through a cellular RF transceiver 1922 with the UE 104. The baseband unit 1904 may include a computer-readable medium/memory. The baseband unit 1904 is responsible for general processing, including the execution of software stored on the computer-readable medium/memory. The software, when executed by the baseband unit 1904, causes the baseband unit 1904 to perform the various functions described supra. The computer-readable medium/memory may also be used for storing data that is manipulated by the baseband unit 1904 when executing software. The baseband unit 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the baseband unit 1904. The baseband unit 1904 may be a component of the base station 310 and may include the memory 376 and/or at least one of the TX processor 316, the RX processor 370, and the controller/processor 375.

The communication manager 1932 may include a request component 1942 that may transmit, to a UE, at least one of an SR configuration to indicate a request for a beam switch or a PRACH configuration representing a set of PRACH resources to indicate the request for the beam switch and receive, from the UE, a PRACH or an SR in a PUCCH that indicates the request for the beam switch for one or more DL or UL channels, e.g., as described in connection with 1602, 1604, 1702, and 1704. The communication manager 1932 further may include a CSI component 1944 that may transmit, to the UE, the scheduling for the CSI report for the implicit beam switch, receive, based on the scheduling, the CSI report for the implicit beam switch, receive, from the UE, an indication of a preferred RS or a preferred TCI state, and transmit, to the UE, a set of CSI measurement resources for evaluating the TCI or the RS associated with the set of PRACH occasions, e.g., as described in connection with 1706, 1708, 1712, and 1714. The communication manager 1932 further may include a beam switch component 1946 that may activate the at least one TCI state and apply the beam switch, e.g., as described in connection with 1710 and 1716.

The apparatus may include additional components that perform each of the blocks of the algorithm in the flowcharts of FIGS. 16 and 17. As such, each block in the flowcharts of FIGS. 16 and 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the baseband unit 1904, may include means for transmitting, to a UE, at least one of an SR configuration to indicate a request for a beam switch or a PRACH configuration representing a set of PRACH resources to indicate the request for the beam switch. The baseband unit 1904 may further include means for receiving, from the UE, a PRACH or an SR in a PUCCH that indicates the request for the beam switch for one or more DL or UL channels. The baseband unit 1904 may further include means for transmitting, to the UE, the scheduling for the CSI report for the implicit beam switch. The baseband unit 1904 may further include means for receiving, based on the scheduling, the CSI report for the implicit beam switch. The baseband unit 1904 may further include means for activating the at least one TCI state. The baseband unit 1904 may further include means for receiving, from the UE, an indication of a preferred RS or a preferred TCI state. The baseband unit 1904 may further include means for transmitting, to the UE, a set of CSI measurement resources for evaluating the TCI or the RS associated with the set of PRACH occasions. The baseband unit 1904 may further include means for applying the beam switch. The means may be one or more of the components of the apparatus 1902 configured to perform the functions recited by the means. As described supra, the apparatus 1902 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, comprising: a memory; and at least one processor coupled to the memory and configured to: receive, from a base station, at least one of a SR configuration to indicate a request for a beam switch or a PRACH configuration representing a set of PRACH resources to indicate the request for the beam switch; and transmit, to the base station, a PRACH or a SR in a PUCCH that indicates the request for the beam switch for one or more DL or UL channels.

Aspect 2 is the apparatus of aspect 1, wherein the request for the beam switch corresponds to a request for an implicit beam switch based on a CSI report, the request being based on a RRC configuration, and wherein the at least one processor coupled to the memory is further configured to: receive, from the base station in response to the SR, the scheduling for the CSI report for the implicit beam switch; and transmit, based on the scheduling, the CSI report for the implicit beam switch.

Aspect 3 is the apparatus of any of aspects 1-2, wherein the at least one processor coupled to the memory is configured to transmit the SR in the PUCCH to request a CSI report associated with an implicit beam switch.

Aspect 4 is the apparatus of any of aspects 1-3, wherein the at least one processor coupled to the memory is configured to: transmit the PRACH in a resource in the set of PRACH resources configured to indicate an implicit beam switch.

Aspect 5 is the apparatus of any of aspects 1-4, wherein the PRACH resource is associated with a TCI state or a RS for the implicit beam switch.

Aspect 6 is the apparatus of any of aspects 1-5, wherein each PRACH occasion in the set of PRACH resources is associated with a TCI or a RS among one or more RSs or TCIs for the implicit beam switch.

Aspect 7 is the apparatus of any of aspects 1-6, wherein the at least one processor coupled to the memory is further configured to: transmit, to the base station, an indication of a preferred RS or a preferred TCI state.

Aspect 8 is the apparatus of any of aspects 1-6, wherein the indication is included in a random access Msg 3 or a random access Msg A PUSCH.

Aspect 9 is the apparatus of any of aspects 1-8, wherein the indication is comprised in a MAC-CE.

Aspect 10 is the apparatus of any of aspects 1-9, wherein the indication is comprised in a CSI report.

Aspect 11 is the apparatus of any of aspects 1-10, wherein the CSI report is associated with a fixed UCI payload with a configured maximum number associated with the one or more RSs or TCIs.

Aspect 12 is the apparatus of any of aspects 1-11, wherein the at least one processor coupled to the memory is further configured to: receive, from the base station, a set of CSI measurement resources for evaluating the TCI or the RS associated with the set of PRACH occasions.

Aspect 13 is the apparatus of any of aspects 1-12, wherein the at least one processor coupled to the memory is further configured to: apply the beam switch at a time based on one of: a PRACH transmission associated with the beam switch, a response from the base station for the PRACH transmission, a CSI report transmission associated with the beam switch, or a confirmation of the CSI report transmission associated with the beam switch from the base station.

Aspect 14 is the apparatus of any of aspects 1-13, wherein the request for the beam switch corresponds to a request for an implicit beam switch based on a CSI report, and wherein the at least one processor coupled to the memory is further configured to: receive, from the base station, the scheduling for the CSI report for the implicit beam switch; and transmit, based on the scheduling, the CSI report comprising at least one RS.

Aspect 15 is the apparatus of any of aspects 1-14, wherein the UE indicates at least one RS in the CSI report, wherein the implicit beam switch is to a beam having a QCL relationship between the at least one RS and at least one TCI state, and wherein the at least one processor coupled to the memory is further configured to: activate the at least one TCI state is indicated independent of a DCI indication.

Aspect 16 is the apparatus of any of aspects 1-15, wherein the UE indicates at least one RS in the CSI report, wherein the implicit beam switch is to a beam having a QCL relationship between the at least one RS and at least one TCI state, and wherein the at least one processor coupled to the memory is further configured to: activate the at least one TCI state independent of a MAC-CE indication.

Aspect 17 is the apparatus of any of aspects 1-16, wherein the beam switch is applied to the one or more DL or UL channels based on a type of a TCI associated with the at least one RS.

Aspect 18 is the apparatus of any of aspects 1-17, wherein the beam switch is applied to the one or more DL or UL channels further based on one or more of: an order associated with the at least one RS, a TCI ID, or a TCI CP ID.

Aspect 19 is the apparatus of any of aspects 1-18, wherein at least one TCI associated with the at least one RS comprises one or more of: a DL TCI for multiple downlink channels, an UL TCI for multiple uplink channels, or a joint TCI for a combination of uplink and downlink channels.

Aspect 20 is the apparatus of any of aspects 1-19, wherein the implicit beam switch applies to multiple channels associated with a PRACH procedure.

Aspect 21 is the apparatus of any of aspects 1-20, wherein the implicit beam switch is based on the CSI report for the implicit beam switch, and wherein the CSI report may be configured to report one or more RSs and corresponding metrics associated with the one or more RSs.

Aspect 22 is the apparatus of any of aspects 1-21, wherein the CSI report comprises one or more DL TCI states.

Aspect 23 is the apparatus of any of aspects 1-22, wherein the CSI report comprises one or more UL TCI states.

Aspect 24 is the apparatus of any of aspects 1-23, wherein the CSI report comprises one or more joint TCI states or a combination of UL and DL TCI states.

Aspect 25 is the apparatus of any of aspects 1-24, wherein the corresponding metrics include one or more of: a RSRP, an SINR, a PHR, a P-MPR, or an MPE.

Aspect 26 is the apparatus of any of aspects 1-26, further comprising a transceiver coupled to the at least one processor.

Aspect 27 is an apparatus for wireless communication at a base station, comprising: a memory; and at least one processor coupled to the memory and configured to: transmit, to a UE, at least one of a SR configuration to indicate a request for a beam switch or a PRACH configuration representing a set of PRACH resources to indicate the request for the beam switch; and receive, from the UE, a PRACH or a SR in a PUCCH that indicates the request for the beam switch for one or more DL or UL channels.

Aspect 28 is the apparatus of aspect 27, wherein the request for the beam switch corresponds to a request for an implicit beam switch based on a CSI report, the request being based on a RRC configuration, and wherein the at least one processor coupled to the memory is further configured to: transmit, to the UE in response to the SR, the scheduling for the CSI report for the implicit beam switch; and receive, based on the scheduling, the CSI report for the implicit beam switch.

Aspect 29 is the apparatus of any of aspects 27-28, wherein the at least one processor coupled to the memory is configured to receive the SR in the PUCCH to request a CSI report associated with an implicit beam switch.

Aspect 30 is the apparatus of any of aspects 27-29, wherein the at least one processor coupled to the memory is configured to: receive the PRACH in a resource in the set of PRACH resources configured to indicate an implicit beam switch.

Aspect 31 is the apparatus of any of aspects 27-30, wherein the PRACH resource is associated with a TCI state or a RS for the implicit beam switch.

Aspect 32 is the apparatus of any of aspects 27-31, wherein each PRACH occasion in the set of PRACH resources is associated with a TCI or a RS among one or more RSs or TCIs for the implicit beam switch.

Aspect 33 is the apparatus of any of aspects 27-32, wherein the at least one processor coupled to the memory is further configured to: receive, from the UE, an indication of a preferred RS or a preferred TCI state.

Aspect 34 is the apparatus of any of aspects 27-33, wherein the indication is included in a random access Msg 3 or a random access Msg A PUSCH.

Aspect 35 is the apparatus of any of aspects 27-34, wherein the indication is comprised in a MAC-CE.

Aspect 36 is the apparatus of any of aspects 27-35, wherein the indication is comprised in a CSI report.

Aspect 37 is the apparatus of any of aspects 27-36, wherein the CSI report is associated with a fixed UCI payload with a configured maximum number associated with the one or more RSs or TCIs.

Aspect 38 is the apparatus of any of aspects 27-37, wherein the at least one processor coupled to the memory is further configured to: transmit, to the UE, a set of CSI measurement resources for evaluating the TCI or the RS associated with the set of PRACH occasions.

Aspect 39 is the apparatus of any of aspects 27-38, wherein the at least one processor coupled to the memory is further configured to: apply the beam switch at a time based on one of: a PRACH transmission associated with the beam switch, a response from the base station for the PRACH transmission, a CSI report transmission associated with the beam switch, or a confirmation of the CSI report transmission associated with the beam switch from the base station.

Aspect 40 is the apparatus of any of aspects 27-39, wherein the request for the beam switch corresponds to a request for an implicit beam switch based on a CSI report, and wherein the at least one processor coupled to the memory is further configured to: transmit, to the UE, the scheduling for the CSI report for the implicit beam switch; and receive, based on the scheduling, the CSI report comprising at least one RS.

Aspect 41 is the apparatus of any of aspects 27-40, wherein the UE indicates at least one RS in the CSI report, wherein the implicit beam switch is to a beam having a QCL relationship between the at least one RS and at least one TCI state, and wherein the at least one processor coupled to the memory is further configured to: activate the at least one TCI state is indicated independent of a DCI indication.

Aspect 42 is the apparatus of any of aspects 27-41, wherein the UE indicates at least one RS in the CSI report, wherein the implicit beam switch is to a beam having a QCL relationship between the at least one RS and at least one TCI state, and wherein the at least one processor coupled to the memory is further configured to: activate the at least one TCI state independent of a MAC-CE indication.

Aspect 43 is the apparatus of any of aspects 27-42, wherein the beam switch is applied to the one or more DL or UL channels based on a type of a TCI associated with the at least one RS.

Aspect 44 is the apparatus of any of aspects 27-43, wherein the beam switch is applied to the one or more DL or UL channels further based on one or more of: an order associated with the at least one RS, a TCI ID, or a TCI CP ID.

Aspect 45 is the apparatus of any of aspects 27-45, wherein at least one TCI associated with the at least one RS comprises one or more of: a DL TCI for multiple downlink channels, an UL TCI for multiple uplink channels, or a joint TCI for a combination of uplink and downlink channels.

Aspect 46 is the apparatus of any of aspects 27-45, wherein the implicit beam switch applies to multiple channels associated with a PRACH procedure.

Aspect 47 is the apparatus of any of aspects 27-46, wherein the implicit beam switch is based on the CSI report for the implicit beam switch, and wherein the CSI report may be configured to report one or more RSs and corresponding metrics associated with the one or more RSs.

Aspect 48 is the apparatus of any of aspects 27-47, wherein the CSI report comprises one or more DL TCI states.

Aspect 49 is the apparatus of any of aspects 27-48, wherein the CSI report comprises one or more UL TCI states.

Aspect 50 is the apparatus of any of aspects 27-49, wherein the CSI report comprises one or more joint TCI states or a combination of UL and DL TCI states.

Aspect 51 is the apparatus of any of aspects 27-50, wherein the corresponding metrics include one or more of: a RSRP, an SINR, a PHR, a P-MPR, or an MPE.

Aspect 52 is the apparatus of any of aspects 27-51, further comprising a transceiver coupled to the at least one processor.

Aspect 53 is a method of wireless communication for implementing any of aspects 1 to 26.

Aspect 54 is an apparatus for wireless communication including means for implementing any of aspects 1 to 26.

Aspect 55 is a computer-readable medium storing computer executable code, where the code when executed by a processor causes the processor to implement any of aspects 1 to 26.

Aspect 56 is a method of wireless communication for implementing any of aspects 27 to 52.

Aspect 57 is an apparatus for wireless communication including means for implementing any of aspects 27 to 52.

Aspect 58 is a computer-readable medium storing computer executable code, where the code when executed by a processor causes the processor to implement any of aspects 27 to 52.

1. An apparatus for wireless communication at a user equipment (UE), comprising:
a memory; and
at least one processor coupled to the memory and configured to:
receive, from a base station, at least one of a scheduling request (SR) configuration to indicate a request for a beam switch or a physical random access channel (PRACH) configuration representing a set of PRACH resources to indicate the request for the beam switch; and
transmit, to the base station, a PRACH or an SR in a physical uplink control channel (PUCCH) that indicates the request for the beam switch for one or more downlink (DL) or uplink (UL) channels.

2. The apparatus of claim 1, wherein the request for the beam switch corresponds to a request for an implicit beam switch based on a channel state information (CSI) report, the request being based on a radio resource control (RRC) configuration, and wherein the at least one processor coupled to the memory is further configured to:
receive, from the base station in response to the SR, the scheduling for the CSI report for the implicit beam switch; and
transmit, based on the scheduling, the CSI report for the implicit beam switch.

3. The apparatus of claim 1, wherein the at least one processor coupled to the memory is configured to transmit the SR in the PUCCH to request a channel state information (CSI) report associated with an implicit beam switch.

4. The apparatus of claim 1, wherein the at least one processor coupled to the memory is configured to:
transmit the PRACH in a resource in the set of PRACH resources configured to indicate an implicit beam switch.

5. The apparatus of claim 4, wherein the PRACH resource is associated with a transmission configuration indicator (TCI) state or a reference signal (RS) for the implicit beam switch.

6. The apparatus of claim 2, wherein each PRACH occasion in the set of PRACH resources is associated with a transmission configuration indicator (TCI) or a reference signal (RS) among one or more RSs or TCIs for the implicit beam switch.

7. The apparatus of claim 6, wherein the at least one processor coupled to the memory is further configured to:
transmit, to the base station, an indication of a preferred RS or a preferred TCI state.

8. The apparatus of claim 6, wherein the indication is included in a random access Msg 3 or a random access Msg A physical uplink shared channel (PUSCH).

9. The apparatus of claim 8, wherein the indication is comprised in a medium access control (MAC) control element (MAC-CE).

10. The apparatus of claim 8, wherein the indication is comprised in a CSI report.

11. The apparatus of claim 10, wherein the CSI report is associated with a fixed uplink control information (UCI) payload with a configured maximum number associated with the one or more RSs or TCIs.

12. The apparatus of claim 6, wherein the at least one processor coupled to the memory is further configured to:
receive, from the base station, a set of channel state information (CSI) measurement resources for evaluating the TCI or the RS associated with the set of PRACH occasions.

13. The apparatus of claim 1, wherein the at least one processor coupled to the memory is further configured to:
apply the beam switch at a time based on one of:
a PRACH transmission associated with the beam switch,
a response from the base station for the PRACH transmission,
a CSI report transmission associated with the beam switch, or
a confirmation of the CSI report transmission associated with the beam switch from the base station.

14. The apparatus of claim 1, wherein the request for the beam switch corresponds to a request for an implicit beam switch based on a channel state information (CSI) report, and wherein the at least one processor coupled to the memory is further configured to:
receive, from the base station, the scheduling for the CSI report for the implicit beam switch; and
transmit, based on the scheduling, the CSI report comprising at least one reference signal (RS).

15. The apparatus of claim 14, wherein the UE indicates at least one RS in the CSI report, wherein the implicit beam switch is associated with a beam having a quasi-colocation (QCL) relationship between the at least one RS and at least one transmission configuration indicator (TCI) state, and wherein the at least one processor coupled to the memory is further configured to:
activate the at least one TCI state independent of a downlink control information (DCI) indication.

16. The apparatus of claim 14, wherein the UE indicates at least one RS in the CSI report, wherein the implicit beam switch is associated with a beam having a quasi-colocation (QCL) relationship between the at least one RS and at least one transmission configuration indicator (TCI) state, and wherein the at least one processor coupled to the memory is further configured to: activate the at least one TCI state independent of a medium access control (MAC) control element (MAC-CE) indication.

17. The apparatus of claim 14, wherein the beam switch is applied to the one or more DL or UL channels based on a type of a transmission configuration indicator (TCI) associated with the at least one RS.

18. The apparatus of claim 17, wherein the beam switch is applied to the one or more DL or UL channels further based on one or more of: an order associated with the at least one RS, a TCI identifier (ID), or a TCI codepoint (CP) ID.

19. The apparatus of claim 14, wherein at least one transmission configuration indicator (TCI) associated with the at least one RS comprises one or more of: a DL TCI for multiple downlink channels, an UL TCI for multiple uplink channels, or a joint TCI for a combination of uplink and downlink channels.

20. The apparatus of claim 19, wherein the implicit beam switch applies to multiple channels associated with a PRACH procedure.

21. The apparatus of claim 14, wherein the implicit beam switch is based on the CSI report for the implicit beam switch, and wherein the CSI report may be configured to report one or more reference signals (RSs) and corresponding metrics associated with the one or more RSs.

22. The apparatus of claim 21, wherein the CSI report comprises one or more DL transmission configuration indicator (TCI) states.

23. The apparatus of claim 21, wherein the CSI report comprises one or more UL transmission configuration indicator (TCI) states.

24. The apparatus of claim 21, wherein the CSI report comprises one or more joint transmission configuration indicator (TCI) states or a combination of UL and DL TCI states.

25. The apparatus of claim 21, wherein the corresponding metrics include one or more of:
a reference signal received power (RSRP), a signal to noise and interference ratio (SINR), a power headroom (PHR), a power management maximum power reduction (P-MPR), or a maximum permissible exposure (MPE).

26. (canceled)

27. An apparatus for wireless communication at a base station, comprising:
a memory; and
at least one processor coupled to the memory and configured to:
transmit, to a user equipment (UE), at least one of a scheduling request (SR) configuration to indicate a request for a beam switch or a physical random access channel (PRACH) configuration representing a set of PRACH resources to indicate the request for the beam switch; and
receive, from the UE, a PRACH or an SR in a physical uplink control channel (PUCCH) that indicates the request for the beam switch for one or more downlink (DL) or uplink (UL) channels.

28. The apparatus of claim 27, wherein the request for the beam switch corresponds to a request for an implicit beam switch based on a channel state information (CSI) report, the request being based on a radio resource control (RRC) configuration, and wherein the at least one processor coupled to the memory is further configured to:
transmit, to the UE in response to the SR, the scheduling for the CSI report for the implicit beam switch; and
receive, based on the scheduling, the CSI report for the implicit beam switch.

29. The apparatus of claim 27, wherein the at least one processor coupled to the memory is configured to receive the SR in the PUCCH to request a channel state information (CSI) report associated with an implicit beam switch.

30.-52. (canceled)

53. A method for wireless communication at a user equipment (UE), comprising:
receiving, from a base station, at least one of a scheduling request (SR) configuration to indicate a request for a beam switch or a physical random access channel (PRACH) configuration representing a set of PRACH resources to indicate the request for the beam switch; and
transmitting, to the base station, a PRACH or an SR in a physical uplink control channel (PUCCH) that indicates the request for the beam switch for one or more downlink (DL) or uplink (UL) channels.

54. A method for wireless communication at a base station, comprising:
transmitting, to a user equipment (UE), at least one of a scheduling request (SR) configuration to indicate a request for a beam switch or a physical random access channel (PRACH) configuration representing a set of PRACH resources to indicate the request for the beam switch; and
receiving, from the UE, a PRACH or an SR in a physical uplink control channel (PUCCH) that indicates the request for the beam switch for one or more downlink (DL) or uplink (UL) channels.
